(19) United States
(12) Patent Application Publication
(10) Pub. No.: US 2014/0035198 A1
(43) Pub. Date: Feb. 6, 2014

(54) METHODS AND APPARATUS FOR MANUFACTURING PREFABRICATED TRENCHES FOR USE IN SHOWER PANS AND OTHER DRAINABLE STRUCTURES

(71) Applicant: Joseph R. Cook, Parkland, FL (US)

(72) Inventor: Joseph R. Cook, Parkland, FL (US)

(21) Appl. No.: 13/752,152

(22) Filed: Jan. 28, 2013

Related U.S. Application Data
(63) Continuation of application No. 13/453,779, filed on Apr. 23, 2012.

(51) Int. Cl. B29C 45/10; B29C 45/14

(52) U.S. Cl. CPC B29C 45/10; B29C 45/14
USPC 264/279; 425/127

(57) ABSTRACT

Methods and apparatus for forming recessed trenches to act with shower pans and other drainable structures, the apparatus comprising one or more tools which employ novel interchangeable components.

### CROSS-REFERENCE TO RELATED APPLICATIONS

N/A.

### BACKGROUND OF THE INVENTION

1. Field of the Invention

The present invention relates generally to showers and other drainable structures, and associated drains and trenches, and more particularly to ready-to-tile molded leak proof shower pans with a molded trench (as herein defined) or prefabricated trench (as herein defined) and a standard drain (as herein defined) attached to the bottom of such trench.

2. Description of the Prior Art

In the design and manufacture of shower bases, it is necessary to provide means by which water can be directed to one or more drain openings by gravity. This is done by way of pitching, or sloping, the floor surface(s) from higher to lower positions on the pan floor, the lower position(s) coinciding with the drain location(s). Given the myriad possible drain locations for any given shower arrangement, it has heretofore been necessary to create an entirely different tool for each drain location, even when a given drain location may differ by as little as one inch from the location of a drain for which a tool already exists.

In addition, most tiled shower pan floors have a multitude of areas that are pitched in different directions from each other, which requires the installer to apply finishing materials thereon such as tile and to cut or install the finishing materials where surfaces which are sloped in different directions intersect. To the greatest extent possible, therefore, it is desirable to have the pan floor pitched as a single planar surface.

Typical shower installations today utilize a centrally located drain, which necessitates the placement of a visible drain fixture somewhere in the tiled shower floor. Although consumers are accustomed to seeing drain fixtures somewhere on the tiled shower floor, it would also be desirable to have a concealed drain to improve the aesthetics of the shower installation (or bath or any other structure from which water is to be drained).

Elongated trench drains (as herein defined) have been proposed. Such trench drains are manufactured as standalone units which must be integrated into a shower stall installation in the field either in a ready-to-tile mortar bed or other hand-made shower pan (as herein defined) or in a ready-to-tile partially prefabricated shower pan (as herein defined). In the case of a mortar bed or other hand-made shower pan, typically, an expensive trench drain assembly is connected to a waste water pipe, and the installer manually forms, pitches, and levels a shower pan from a bed of mortar or like material installed in the field or elsewhere on any subfloor, requiring the mortar bed to be waterproofed using a vinyl liner, a membrane liner, hot mopping or otherwise waterproofed, either below the formed shower pan floor, usually before the shower pan floor surface is formed, or on the top of the formed shower pan surface after it is formed, or both, and then the installer attempts to make a leak proof connection between the trench drain and the mortar bed or other handmade shower pan. Similarly, in the case of a partially prefabricated shower pan, the installer attempts to make a leak proof connection between the partially prefabricated shower pan and the trench drain, and then attempts to water proof the upper or lower surface of the partially prefabricated shower pan, or both, together with all seams between component parts. However, such arrangements are expensive, and it is commonplace for leaks to develop at the connections between (a) the trench drain and the mortar bed or other handmade shower pan, (b) the trench drain and the partially prefabricated shower pan, (c) any other seams in the mortar bed or other handmade shower pan, and (d) any other seams in the partially prefabricated shower pan, rendering such non-unitarily manufactured arrangements highly undesirable.

There are no ready-to-tile prefabricated shower pans (as herein defined) on the market today with (a) an integrated trench drain, (b) an integrated molded trench and a standard drain, (c) an integrated prefabricated trench and a standalone standard drain, and (d) a prefabricated trench with an attached standard drain prefabricated as a single unit and then integrally molded into the prefabricated shower pan. Likewise, there are no ready-to-tile partially prefabricated shower pans on the market today with (a) a standalone standard drain and a prefabricated trench as two components of a partially prefabricated shower pan assembly, (b) a prefabricated trench and a standard drain attached thereto as a single component of a prefabricated shower pan assembly, and (c) a prefabricated trench or a molded trench incorporated into a partially prefabricated shower pan floor to which a standalone standard drain is attached. Similarly, a standalone standard drain and a prefabricated trench is not available on the market today for use in a mortar bed or other handmade shower pan.

Likewise, there are no ready-to-tile shower pans on the market today with a trench, to which trench a standard drain is attached, where (a) the trench is made from a computer numerically controlled lathe, or (b) the shower pan floor is made from a computer numerically controlled lathe and a trench drain or a trench with a standard drain is then connected to the shower pan floor, or (c) both the shower pan floor and the trench are made from a computer numerically controlled lathe and a standalone standard drain is attached to such trench. Applying such technology to the manufacture of shower pans with trench drains, or to shower pans with trenches and standalone standard drains attached to such trenches, would also be highly desirable.

It would be desirable if a suitable leak proof arrangement can be arrived at in the manufacture of a ready-to-tile prefabricated shower pan (a) for joining a standalone trench drain with a ready-to-tile prefabricated shower pan; (b) for joining a standalone standard drain with a ready-to-tile prefabricated shower pan with a molded trench; (c) for joining a standalone prefabricated trench and a standalone standard drain with a ready-to-tile prefabricated shower pan; and (d) for joining a standalone prefabricated trench with a standard drain attached to such trench as a single unit with a ready-to-tile prefabricated shower pan.

It would also be desirable if a suitable arrangement can be arrived at in the manufacture and installation of a partially prefabricated shower pan, either at the time of manufacture or post-manufacture, such as in a post-manufacturing step prior to or during distribution, or in the field during construction of the shower stall, (a) for joining a standalone standard drain and a standalone prefabricated trench with other components of a ready-to-tile partially prefabricated shower pan; (b) for joining a prefabricated trench to which a standalone standard drain is attached with other components of a partially prefabricated shower pan; and (c) for joining a standalone prefabricated floor panel containing a trench to which a standard drain is attached with other components of a partially prefabricated shower pan.

It would also be desirable if a suitable arrangement can be arrived at in the installation of a mortar bed or other handmade shower pan, either at the time of manufacture or post-manufacture, such as in a post-manufacturing step prior to or during distribution, or in the field during construction of the shower stall (a) for joining a standalone prefabricated trench and a standalone standard drain with a mortar bed or other handmade shower pan, and (b) for joining a standalone trench with an attached standard drain as a single unit with a mortar bed or other handmade shower pan.

Each of the foregoing arrangements also enjoy one or more of the following benefits: easier installation, more leak proof, and less expensive, because they are incorporating and combining standard drains and molded or prefabricated trenches. Most existing stand alone trench drains are made of metal as an integrated unit and approved as such under various plumbing codes and have the actual floor drain hookup integrated as part thereof, resulting in a prohibitively expensive product.

Therefore, a need exists for, among other things, molded or prefabricated trenches that are inexpensive to manufacture, easy to install, are part of a unitary molded prefabricated shower pan or part of a multi piece partially prefabricated shower pan assembly or part of a Mortar bed or other handmade shower pan, which when installed in the field, is ready-to-tile, and contains a trench which is attached to or part of the shower pan to which a standard drain is attached. A need also exists for a one piece ready-to-tile shower pan with a trench drain integrally formed into such shower pan.

Utilizing the novel manufacturing tools and methods which I have developed, (a) I can mold one piece ready-to-tile and leak proof prefabricated shower pans which contain one or more of, an integrated and pitched shower pan floor, integrated splash walls, and integrated curb and/or barrier free entrance, with either an integrated trench drain or an integrated standalone trench and a standalone standard drain at the bottom of the trench; and (b) I can prefabricate or mold trenches of various sizes and shapes as standalone units, or as part of a shower pan floor, which then can be joined with standalone standard drains, either at the time of manufacture or post-manufacture, such as in a post-manufacturing step prior to or during distribution, or in the field during construction of a shower stall, as part of a partially prefabricated shower pan assembly and as part of a mortar bed or other hand made shower pan. Heretofore no such arrangements exist.

There is also a need in a prefabricated shower pan, a partially prefabricated shower pan, and in a mortar bed or other handmade shower pan, to inexpensively vary the width, length, depth, and shape of the molded or prefabricated trench, together with a need to vary the location of the molded or prefabricated trench in the shower pan, change the location of the standalone drain in the trench, alternatively have multiple standalone drains in a trench, line the trench, pitch the trench, raise and lower non tileable and tileable grates which cover the trench so they can be the height of the adjoining tile, space the tileable and non tileable drain grates appropriately from the trench sidewalls and/or the trench liner, as the case may be, for appropriate drainage, and to insert reducers into the trench to reduce either the length, the width and/or other dimension(s) of the trench. The trench and any trench liner can also have a molded or prefabricated aperture where the standalone drain attaches to the trench, or such aperture in the liner or the trench, or both, can be installed some time after the manufacture of the trench and the liner, either at the time of manufacture of the trench or the liner, or post-manufacture, such as in a post-manufacturing step prior to or during distribution, or in the field during construction of the shower stall.

Existing technology does not permit this kind of flexibility in connection with molded or prefabricated trenches and standalone standard drains used in connection with ready-to-tile prefabricated shower pans, ready-to-tile partially prefabricated shower pans, ready-to-tile mortar bed or other handmade shower pans, and non tileable shower pan trenches.

Utilizing the novel manufacturing tools and methods which I have developed, I can provide all of the features described in paragraphs 16 and 17 above to molded or prefabricated trenches used with or without standalone standard drains in connection with ready-to-tile prefabricated shower pans, ready-to-tile partially prefabricated shower pans, ready-to-tile mortar bed or other handmade shower pans, and non tileable shower pan trenches.

### SUMMARY OF THE INVENTION

In one embodiment, a trench drain (as defined herein) is integrally formed with a ready-to-tile prefabricated shower pan (as defined herein) at the time of manufacture of the shower pan, such as, but not limited to, the type of prefabricated shower pan disclosed in U.S. Pat. No. 5,913,777 entitled “Pre-Fabricated Shower Module and Method of Shower Construction.

In another embodiment, a standalone standard drain body (as defined herein) is integrally formed with a ready-to-tile prefabricated shower pan (as defined herein) containing a trench formed as part of such molding process, where the standard drain body is located at the bottom of such trench at the time of manufacture of the shower pan.

In another embodiment, a standalone prefabricated trench and a standalone standard drain body are integrally formed with and molded in a prefabricated ready-to-tile shower pan (as defined herein) at the time of manufacture of the shower pan.

In another embodiment, a prefabricated trench and a standalone standard drain are integrally formed into a single unit, which single unit is then integrally formed with and molded in a prefabricated shower pan at the time of manufacture of the shower pan.

In another embodiment, a standalone prefabricated trench and a standalone standard drain body (as herein defined) are two components of a partially prefabricated shower pan assembly and subsequently incorporated with a partially prefabricated shower pan sometime after manufacture and in many cases in the field at or about the time of installation of the partially prefabricated shower pan.

In another embodiment, a prefabricated trench (as herein defined) and a standalone standard drain body are integrally formed as one component of a partially prefabricated shower pan assembly and subsequently incorporated with the partially prefabricated shower pan sometime after manufacture and in many cases in the field at or about the time of installation of the partially prefabricated shower pan.

In another embodiment, a molded or prefabricated trench body is integrally formed with the floor or a portion of the floor of a partially prefabricated shower pan and a standalone standard drain body is then affixed to the floor of such trench as part of a partially prefabricated shower pan sometime after manufacture and in many cases in the field at or about the time of installation of the partially prefabricated shower pan.

In another embodiment, a molded or prefabricated trench and standalone standard drain are integrally formed as one unit, and then as one unit integrally formed with the floor or a portion of the floor of a partially prefabricated shower pan and subsequently installed in the field at or about the time of installation of the partially prefabricated shower pan.

In another embodiment, a standalone prefabricated trench and a standalone standard drain body (as herein defined) are two components of a mortar bed or other handmade shower pan assembly and subsequently incorporated in the mortar bed or other handmade shower pan sometime after manufacture and in many cases in the field at or about the time of installation of the partially prefabricated shower pan.

In another embodiment, a prefabricated trench (as herein defined) and a standalone standard drain body are integrally formed as one component of a mortar bed or other handmade shower pan assembly and subsequently incorporated as a unit to the mortar bed or other handmade shower pan sometime after manufacture and in many cases in the field at or about the time of installation of the partially prefabricated shower pan.

In another embodiment, a standalone standard drain body and a molded or prefabricated trench are incorporated in a prefabricated shower pan, a partially prefabricated shower pan and a molded or other handmade shower pan such that (a) the standard drain is adapted to be placed in registry with a floor drain pipe regardless of when it is attached to or incorporated into the shower pan, (b) the trench is recessed into or formed below the shower pan floor so that water will drain from the shower pan floor into the trench, (c) the trench is recessed into or formed below the shower pan floor to accommodate a trench or cover, (d) a floor of the trench defines at least one drain aperture, (e) the standard drain is attached to the aperture in the bottom of the trench, (f) a trench cover, which can be covered with stone, tile, concrete, stucco or other floor or wall covering, or can be apertured, is associated with the trench body in such a way that (i) it covers all or a portion of the trench so that an upper surface of the trench cover is substantially coplanar with an upper surface of the floor of the shower pan surface, (ii) both the shower pan and the trench cover can be covered with tile, stone, or other floor or wall covering, so that it will blend into the flooring material used on the surrounding partially prefabricated shower pan floor, (iii) the trench cover is attachable to the trench or the prefabricated shower pan, the partially prefabricated shower pan, and the mortar bed or other handmade shower pan, (iv) the trench cover is optionally removable and/or interchangeable with other trench covers, (v) the trench top, grate or cover permits water to drain into the trench body along the outside perimeter of the trench cover and/or drain through apertures in the cover, (vi) the trench cover also permits water or other liquid to drain in a gap created when the trench cover is placed in registry with the trench because the peripheral edges (or a portion thereof) of the trench cover are spaced from the trench peripheral sidewalls so as to define a gap therebetween through which water or other liquid may pass into the trench and flow to the standard drain attached to the floor of the trench, and (vii) the trench cover permits water to drain into a gap between one or more of the perimeter tiled or tileable edges of the trench cover and one or more of the adjacent tiled or tileable perimeter edges of the trench, (viii) the trench is sufficiently recessed into or below an upper surface of the prefabricated shower pan floor, the partially prefabricated shower pan floor, and the mortar bed or other handmade shower pan floor, so that an upper surface of the tiled or tileable trench cover when attached in substantial registry with the trench is substantially coplanar with the adjacent upper surface of the tiled or tileable shower pan floor, and the lower surface of the attached trench cover and the upper surface of the trench body floor are spaced so that a sufficient gap is created to allow for water to drain therethrough into the trench, (ix) a standard drain is attached to the floor of the trench so that the water flowing into the trench will flow through the standard drain into the drain aperture defined by the standard drain, (x) the trench cover covers substantially the entirety of the trench, the standard drain body attached thereto, and the drain aperture from view while permitting water to flow into and along the trench, the standard drain apparatus and the drain aperture, and (xi) optionally, a removable strainer can be placed in the standard drain between the trench or cover and the drain aperture. The trench and the trench cover can be made of any appropriate material including but not limited to plastic such as PVC or ABS, polyurethane, polyethylene, polymer resin, metal such as copper, cast iron, aluminum, steel, or building materials such as stone, concrete, marble, cultured marble, mortar, stucco or any other material.

In another embodiment, a prefabricated shower pan, a partially prefabricated shower pan, and a mortar bed or other handmade shower pan is formed with a molded trench or prefabricated trench such that the trench (a) can be any length, width, depth and shape, (b) can be located anywhere in the shower pan, (c) can have any drain location in the trench, (d) can have multiple drain locations in the trench, (e) can have a standard drain attached to the trench, (f) can have a flat inside floor of the trench, (g) can have a molded or prefabricated V pitch incorporated into the trench at the time it is made which forms a V pitch from the narrow sides of the trench to the center of the trench floor to facilitate drainage from the trench, or such pitch can be subsequently incorporated into the trench by a liner, (h) can have a molded or prefabricated pitch incorporated into the trench at the time the trench is made which forms a planar pitch from both long ends of the trench to the drain aperture in the trench to facilitate drainage of water, (i) can have a liner installed in the trench any time after the trench is molded or prefabricated, (k) can shorten the trench or make it narrower by installing spacers into a liner installed in the trench or directly into the trench at any time after the trench is molded or prefabricated, (k) can have the trench converted into a different length or width through spacers so that different length and width trench covers can be used in the trench, (l) the trench liners, inserts, and spacers can be made of any appropriate material, including but not limited to plastic such as PVC or ABS, polyurethane, polyethylene, polymer resin, metal such as copper, cast iron, aluminum, steel, or building materials such as stone, concrete, marble, cultured marble, mortar, stucco or any other material.

### BRIEF DESCRIPTION OF THE DRAWINGS

FIG. 1 is a flow diagram demonstrating a method for producing a novel shower pan and integrally incorporated standard trench drain.

FIG. 2 is a perspective view of a standard trench drain.

FIG. 3 is a cross-sectional elevational view of a water proof shower pan with a standard trench drain integrally incorporated therewith.

FIG. 4 is a perspective view of a waterproof shower pan with an integrated standard trench drain connected thereto.

FIG. 5 is a top plan view of the pan of FIG. 4.

FIG. 6 is a cross-sectional elevational view thereof taken along lines 6-6 of FIG. 5.

FIG. 7 is a flow diagram of a first alternative manufacturing method in accordance with this invention.

FIG. 8 is a top plan view of a waterproof shower pan made in accordance with the manufacturing method of FIG. 7.

FIG. 9 is a perspective view thereof.

FIG. 10 is a cross-sectional elevational view thereof taken along lines 10-10 of FIG. 8.

FIG. 11 is a top plan view of the pan of FIGS. 8-10 but with a shorter trench.

FIG. 12 is a perspective view thereof.

FIG. 13 is a cross-sectional elevational view thereof taken along lines 13-13 of FIG. 11.

FIG. 14 is a top plan view of the pan of FIGS. 8-13, but with a narrower trench.

FIG. 15 is a perspective view thereof.

FIG. 16 is a cross-sectional elevational view thereof taken along lines 16-16 of FIG. 14.

FIG. 17 is a flow diagram for a method of manufacturing waterproof shower pans with integrated prefabricated trenches and standard drains.

FIG. 18 is a perspective view of a pre-manufactured trench.

FIG. 19 is a top plan view thereof.

FIG. 20 is a cross-sectional elevational view thereof taken along lines 20-20 of FIG. 19.

FIG. 21 is a flow diagram of a process for manufacturing waterproof shower pans with integrated trenches into which standard drains have been incorporated.

FIG. 22 is a perspective view of a pre-manufactured trench having a standard drain attached thereto at the time of manufacture of the trench.

FIG. 23 is a top plan view thereof.

FIG. 24 is a cross-sectional elevational view thereof taken along lines 24-24 of FIG. 23.

FIG. 25 is a flow diagram of a process for manufacturing partially pre-fabricated waterproof shower pans with separate trenches into which standard drains have been incorporated.

FIG. 26 is a perspective exploded view of exemplary components of a partially pre-fabricated shower pan in accordance with this embodiment.

FIG. 27 is an assembled top plan view thereof.

FIG. 28 is an assembled cross-sectional side elevational view thereof.

FIG. 29 is a flow diagram of an alternative process for manufacturing partially pre-fabricated waterproof shower pans with separate trenches into which standard drains have been incorporated.

FIG. 30 is a flow diagram of a process for manufacturing a pre-fabricated shower pan wherein the shower pan floor defines a trench.

FIG. 31 is a perspective exploded view of a partially pre-fabricated shower pan arrangement wherein the pan floor defines a trench.

FIG. 32 is a perspective view of a partially pre-fabricated shower pan floor defining a trench in an alternative location.

FIG. 33 is a cross-sectional elevational view thereof taken along lines 33-33 of FIG. 32.

FIG. 34 is a perspective view of a partially pre-fabricated shower pan floor manufactured from separate components.

FIG. 35 is a cross-sectional elevational view taken along lines 35-35 of FIG. 34.

FIG. 36 is a perspective view of yet another embodiment of a partially pre-fabricated shower pan floor defining a trench.

FIG. 37 is a cross-sectional elevational view thereof taken along lines 36-36 of FIG. 35.

FIG. 38 is a cross-sectional exploded elevational view of a shower pan floor defining a trench and showing a trench insert and non-tileable cover.

FIG. 39 is an assembled cross-sectional elevational view of the trench, insert and non-tileable cover shown in FIG. 38.

FIGS. 40-41 depict the arrangement showing in FIGS. 38-39 but with a tileable trench cover.

FIG. 42 is a perspective exploded view of the pan floor/trench/insert/non tileable cover arrangement shown in FIGS. 38-39.

FIG. 43 is a perspective exploded view of a slightly modified version of the arrangement shown in FIGS. 38-39.

FIGS. 44-45 show a trench or trench insert having floor modules used to create floor pitch.

FIGS. 46-49 show arrangements for providing prefabricated shower pan floors with integrated trenches and standard drains.

FIGS. 50-56 show prefabricated shower pan floors having integrated trenches and trench inserts therefore.

FIGS. 57-58 depict a modified trench cover support for both supporting and permitting height adjustment of trench covers.

FIGS. 59-63 show an alternative structure for supporting trench covers.

### DETAILED DESCRIPTION OF EXEMPLARY EMBODIMENT(S)

Before describing in detail exemplary embodiments pertaining to the present invention, it should be observed that the inventive embodiments of my invention reside primarily in combinations of structural components and manufacturing, installation and use steps related to the creation, implementation, installation and use of trench drains or trench bodies with a standard drain in showers and other apparatus where liquid drainage is required.

Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements.

The terms “comprises,” “comprising,” “comprise” or any other variation thereof are intended to cover a non-exclusive inclusion, such that a process, method, article, or apparatus that comprises a list of elements need not necessarily include only those elements, but may include other elements not expressly listed or inherent to such process, method, article, or apparatus.

The term “plurality of” as used in connection with any object or action means two or more of such objects or actions.

A claim element proceeded by the article “a” or “an” does not, without more constraints, preclude the existence of additional identical elements in the process, method, article, or apparatus that includes the element.

Terms such as “wall or flooring material,” “floor and wall covering”, flooring material and “covering material” mean, encompass and comprise one or more of ceramic, natural stone or other tile, stone, granite, marble, cultured marble, or any other stone surface, non slip finished shower surfaces such as vinyl or plastic, stucco, concrete and mortar surfaces, whether or not applied or combined with adhesives or other substances, and any other material or materials used to provide a finished surface.

The term “tiled” means, encompasses and comprises any surface having floor or wall covering materials, such as one or more of ceramic, natural stone or other tile, stone, granite, marble, cultured marble. or other stone surface, non slip finished shower surfaces such as vinyl or plastic, stucco, concrete and mortar surfaces which may be mixed with adhesives or other substances, and any other material or materials used to provide a finished surface.

The term “non tileable” means, encompasses and comprises one or more surfaces or structural components which are not capable of receiving wall or floor material or were not designed, marketed or sold with the intention of being tileable or tiled, and in fact are not tiled.

The term “tileable” or “ready-to-tile” means, encompasses, and comprises one or more surfaces or structural components which are capable of receiving wall or flooring material, whether through the use of adhesives or any other means of attachment, such as clips, straps or other mechanical fastening structure(s).

The term “prefabricated shower pan” means, encompasses and comprises any manufactured or fabricated tileable or tiled one piece shower pan (A) to which floor or wall coverings may be adhered, (B) which at the time of manufacture has either (i) a trench integrally associated therein or (ii) a molded or prefabricated trench integrally formed with one or more standard drain bodies, both of which are integrally associated into the shower pan at the time of manufacture or fabrication of such shower pan, and (C) which may also have integrated therein at the time of manufacture or fabrication a floor (which may be pitched), a splash wall, a curb, and/or a barrier free entrance.

The term “partially prefabricated shower pan” means, encompasses and comprises any manufactured or fabricated tileable or tiled shower pan assembly or kit to which floor or wall coverings are to be adhered which is not a one piece shower pan, but has two or more pieces which are assembled at any time after manufacture and prefabrication, usually in the field at or around the time of assembly and installation of the shower pan, which when assembled and installed in the field comprises a one piece or multi-piece shower floor and which does not have (A) either (i) a molded or prefabricated trench together with a standard drain integrally formed into such tiled or tileable shower pan at the time of manufacture or (ii) a trench drain integrally formed into such tiled or tileable shower pan at the time of manufacture, but which may have (B) a manufactured or fabricated integrated or component elements such as a floor, a splash wall, a curb and/or a barrier free entrance, and (C) as individual components one or more of a trench drain body, a standard drain body, a trench body, an integrally formed trench body and a standard drain, a trench body integrally formed with a all or a portion of a shower pan floor, and a trench body and a standard drained integrally formed with a all or a portion of a shower pan floor.

Terms such as “mortar bed or other hand-made shower pan” and “mortar bed and shower pan” mean, encompass and comprise a shower floor, bath floor, a shower pan, a shower base, floor or other surface that is partially of fully formed by a bed of mortar or like material installed in the field or elsewhere on any subfloor, including but not limited to concrete, wood, or steel, into which, in conjunction with, or below which, a trench and a drain is installed, and the mortar bed may be waterproofed using a vinyl liner, a membrane liner, hot mopping, or otherwise waterproofed, and floor or wall coverings are or may be adhered to the surface of the mortar bed, and which has as individual components such as one or more of a trench drain body, a standard drain body, a trench body, an integrally formed trench body and a standard drain, a trench body integrally formed with all or a portion of a shower pan floor, and a trench body and a standard drained integrally formed with all or a portion of a shower pan floor.

Terms such as “tiled and/or tileable surface or fixture” and “surface or fixture” mean, encompass, and comprise any fully or partially tiled and/or tileable bathtub, bathroom floor, shower floor, sink, fountain, fixture, floor, or other surface.

The term “non tileable and/or untiled surface” means, encompasses or comprises a surface such as a floor, wall, shower floor, bath floor, sink, shower pan, or any other surface which has a drain integrated or associated with it, and such surface is either not tileable, or is not designed to be tiled or tileable, and/or such surface is in fact not tiled.

The term “standard drain” means, encompasses and comprises any kind of drain made of any kind of material, including but not limited to metal or plastics, and with any kind of connection to a drain system such as a waste water system, including but not limited to a a solvent weld drain, a welded connection drain, a hub (outside caulk) drain, a spigot drain, a hubless spigot drain, a hubless drain, an inside caulk (gasket) drain, a hubbed (push on) drain, a compression drain, and a clamping ring drain, but does not include a trench drain.

The term “trench drain” means, encompasses and comprises existing integrally formed trench drains such as those which meet the requirements of the various plumbing codes pertaining to a trench drain.

Terms such as “trench top, grate or cover” and “trench cover” mean, encompass and comprise anything that covers all or a portion of a trench or a trench drain, whether it is manufactured as part of the trench or trench drain or is separately made and placed over or in registry with all or any part of the trench or trench drain, and whether it is one piece or multiple pieces which in combination cover all or a portion of the trench or trench drain, and such trench top, grate or cover may be made out of one or more materials, including but not limited to metal, such as cast iron, copper, steel, aluminum, plastics such as PVC or ABS, polyurethane, polyethylene, polymer resin, building products such as stone, tile, concrete, marble, cultured marble, mortar, stucco or the like, or any other material suitable as a trench top or cover.

A “trench body” or “trench” means, encompasses and comprises molded trench bodies or preformed or prefabricated trench bodies and other voids into which liquids may otherwise drain, such as depressions in a shower, bath, basin or bathroom floor, whether preformed or formed during the assembly of the shower pan, bath tub, basin or floor which may or may not be leak proof at the time the trench body is preformed, prefabricated, or molded, or subsequently made water proof sometime after manufacture such as in the field at or about the time of installation of the shower pan, and which is made from any appropriate material including but not limited to metal, such as cast iron, copper, steel, aluminum, plastics such as PVC or ABS, polyurethane, polyethylene, polymer resins, or the like.

The term “pre-manufactured” means, encompasses and comprises any component of a shower pan that is manufactured prior to incorporation of that component into another product.

The term “molded’ means, encompasses and comprises any component that is formed with a shower pan at the time that the shower pan is molded.

The term “grate free” means any area over, near or in registry with a drain into which water or other liquid may drain which is substantially free of obstruction.

The inventions disclosed herein may be employed in sinks, basins, showers, baths, shower pans, fixtures, and any other surface or fixture from which liquid is to be drained.

The terms “pitch” or “slope” mean the change in elevation per unit of length of floor. An acceptable pitch is ¼″ per foot, although any pitch is deemed to be within the scope of the inventions disclosed herein.

The present invention is directed to one or more trench bodies, trench drains, and standard drains which are integrated in into or with, or used independently or in combination with, shower pans such as: (i) a prefabricated shower pans, (ii) a partially prefabricated shower pans, (iii) a mortar bed or a hand made shower pan floors, (iv) a tiled or tileable surfaces or fixtures.

### 1. Leak Proof Prefabricated Shower Pans and Standard Trench Drains Integrated Therewith at Time of Manufacture.

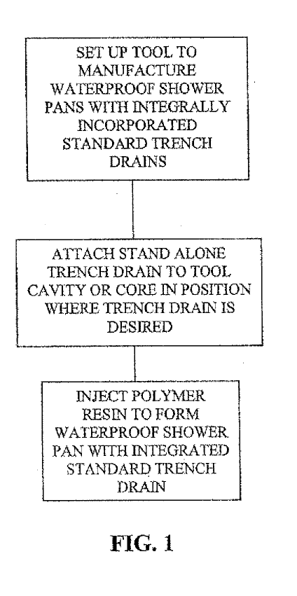

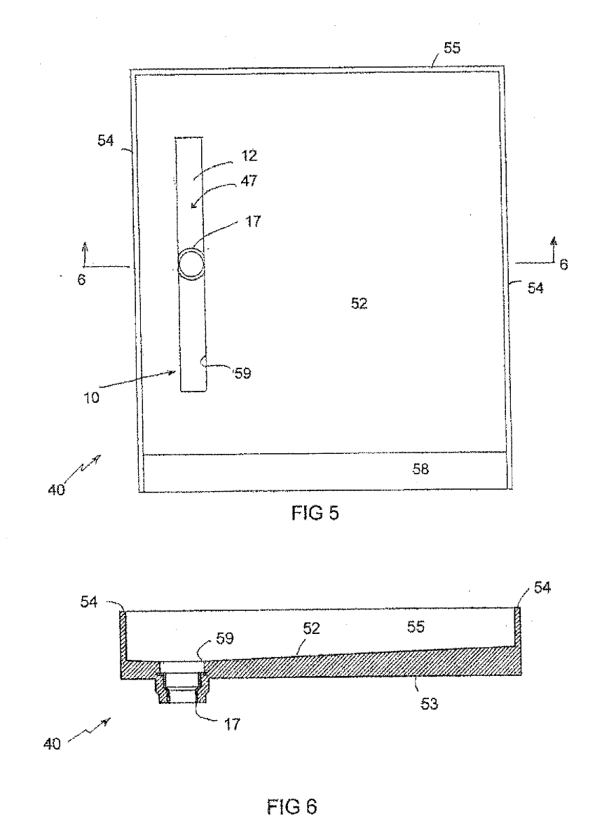

FIGS. 1 through 6 depict a flow diagram for a manufacturing process, and examples of resulting products. The process comprises the steps of: (1) setting up a tool to manufacture leak proof prefabricated shower pans having integrally incorporated therein a stand alone standard trench drain; (2) attaching a stand alone standard trench drain to the tool cavity or core in a position where the trench drain is desired to be located; and (3) injecting polymer resin into the tool to form a leak proof shower pan with an integrated standard trench drain at least partially encapsulated therein.

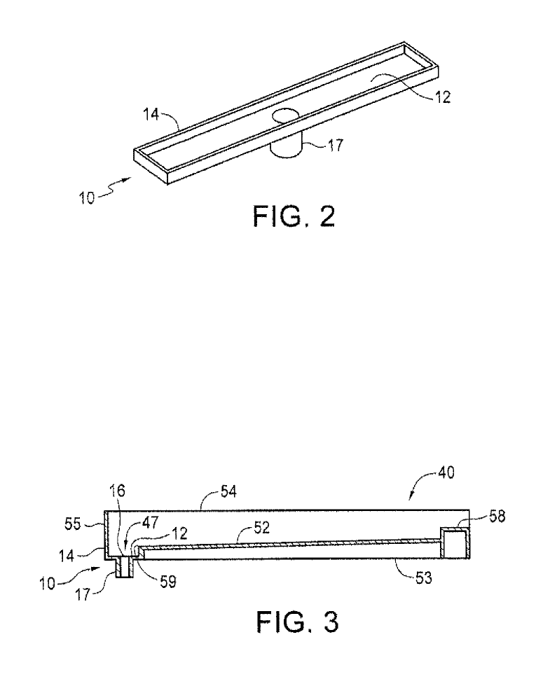

FIG. 2 shows a typical standard trench drain, which is a unitary product comprising generally a floor 12, sidewalls 14 and a drain apparatus 17. Standard trench drains come in a myriad of configurations and sizes. The purpose of this aspect of the invention, which has heretofore never been offered on the market, is to incorporate a standard trench drain into a one-piece leak proof prefabricated shower pan at the time the prefabricated shower pan is manufactured, resulting in a one piece, integrated leak proof prefabricated shower pan and trench drain, such as that shown in FIGS. 3-6. In FIG. 3, a typical shower pan 40 is produced, which includes a shower pan floor 52. Standard trench drain 10 has been incorporated therein, such that one sidewall 14 of standard trench drain 10 adjoins shower pan floor 52 along a terminal edge 59 of floor 52. Sidewalls 54, and end sidewall 55, may be incorporated into the pan 40, as well as entry curb 58, and any other features deemed desirable. Standard trench drain 10 forms a trench 47 into which liquid may flow and subsequently exit through drain apparatus 17. The pan 40 shown in FIG. 3 has the trench drain oriented opposite the entry curb 58.

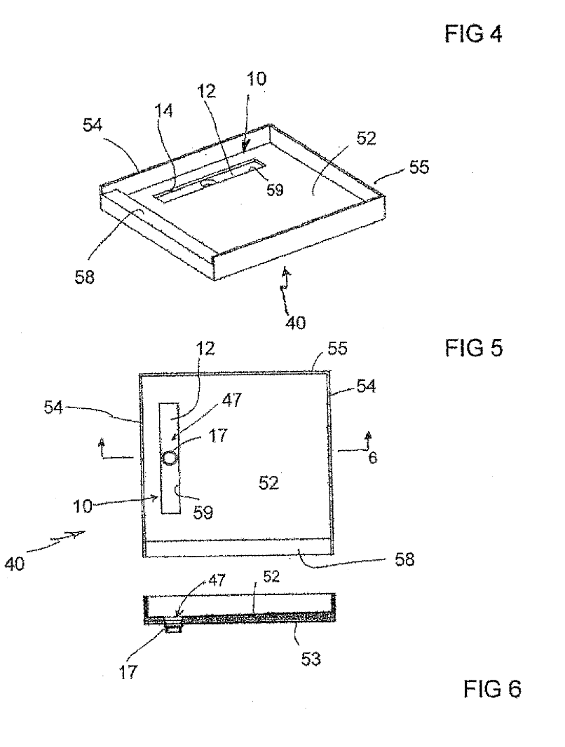

As shown in FIGS. 4-6, standard trench drain 10 may be incorporated into pan 40 in any orientation. In the orientation shown, standard trench drain 10 is positioned perpendicularly to entry curb 58 of pan 40. In either version of pan 40, preferably, the pan will end in a planar bottom surface 53, which may be defined by ribs or a flat surface, or any other desired arrangement.

Drain apparatus 17, as is known to those of skill in the art, is whatever type of waste water drain connection may be associated with a standard trench drain 10, and is adapted to be attached to the existing floor waste water drain pipe. Any suitable technique and/or structural arrangement for creating a rigid interconnection between pan 40 and standard trench drain 10 is within the scope of the invention. Preferably, the standard trench drain is molded with and into the prefabricated shower pan so that it is at least partially encapsulated and/or at least partially molded into the prefabricated shower pan.

2. Leak Proof Prefabricated Shower Pan Containing a Trench Formed in Such Shower Pans as Part of the Molding Process with a Standard Drain Integrally Formed in the Shower Pan in the Floor of the Trench at Time of Manufacture of the Pan.

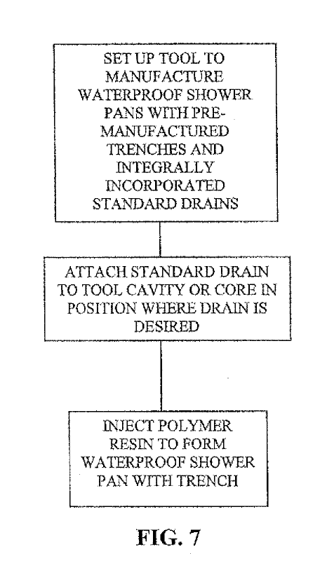

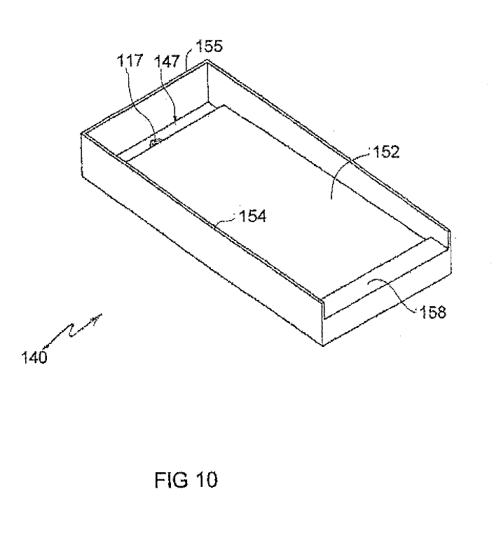

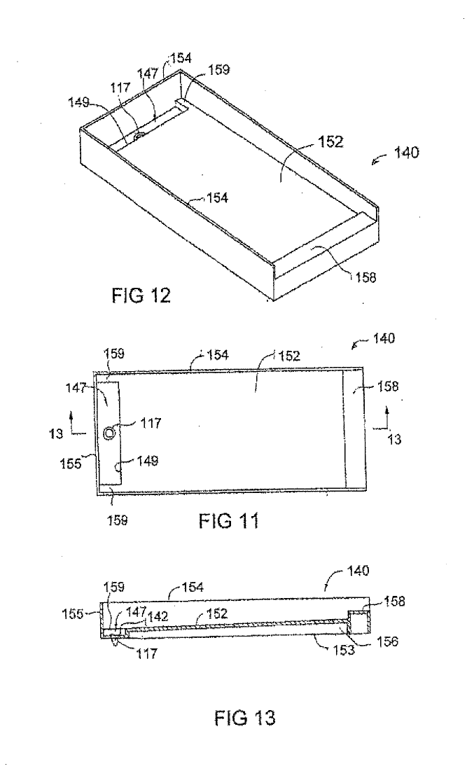

FIGS. 7-16 depict a flow diagram for another manufacturing process and examples of resulting products. The process comprises the steps of: (i) setting up a tool to manufacture leak proof prefabricated shower pans with integrally formed trenches as part of the molding process; (ii) attaching a standard drain to the tool cavity or core in a position where the drain is desired; and (iii) injecting polymer resin to form a leak proof prefabricated shower pan with an integrally formed trench and standard drain attached to the bottom of the molded trench.

Referring now to FIGS. 7-16B, there is shown a one-piece prefabricated shower pan 140 with an integrally molded trench 147. The pan 140 is comprised of a pitched floor 152 (which is preferably pitched) defining bottom surface 153 thereof, whether with or without ribs 156, curb 158, one or more side or splash walls 154, and a rear splash wall 155. Trench 147 is defined by a trench floor 142 and trench sidewalls 143. Trench sidewalls 143 may coincide with the inner-facing surface of rear splash wall 155 and/or splash walls 154 or it may coincide with any combination of the shower pan floor and side/splash walls. A drain aperture 116 is defined by trench floor 142, and is created during manufacture by the inclusion of a standard drain body 117 in the cavity or core portion of the tool used to manufacture pan 140. The location of drain 117 is determined by the location of the waste water pipe (not shown) in the sub-floor.

The depth of trench 147, and, hence, the height of trench sidewalls 143, are determined by the needs of the particular application, but need not be substantial. It will ordinarily be desirable that the bottom surface 153 of pan 140 be coplanar (i.e. coextensive) with or fully contained within the bottom surface of trench 147, as best seen in FIGS. 7, 10, 13-16. In this way, an installation, whether in new construction or a retrofit of an existing shower or bath tub, can simply be accomplished by placing pan 140 in the space allocated for the shower installation, and drain body 117 aligned with the existing waste water pipe (not shown).

As can be seen from the drawings, floor 152 is pitched or sloped from curb 158 toward trench 147. A standard slope is ¼ inch per foot, although any pitch which will accomplish the task of causing liquid to drain from floor 152 into trench 147 is deemed to be within the scope of the invention. Providing a floor 152 with a uniformly pitched (i.e. planar) surface makes the job of affixing finishing material thereto far easier than if there are undulations (changes in pitch) thereupon.

Referring now to FIGS. 11-13, there is shown a slightly modified form of the invention shown in FIGS. 7-10, in which floor 152 is extended along the edges of trench 147 to accommodate a shorter trench. Surfaces 159 are used to fill the area between the edges of trench 147 and splash walls 154. Floor extensions 159 may be pitched toward trench 147 to facilitate the drainage of liquid into trench 147, or may be horizontal.

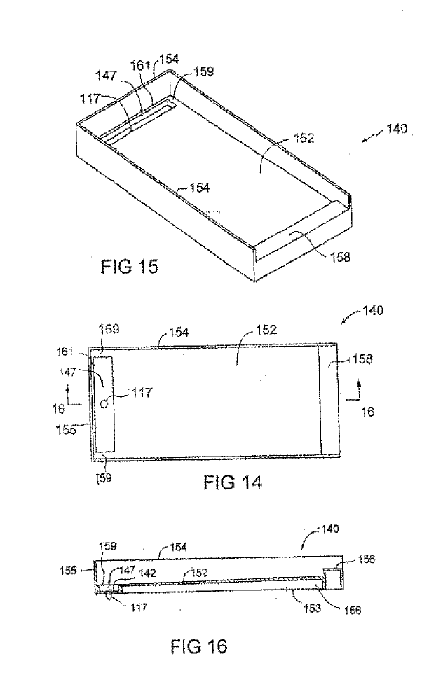

A further variation is shown in FIGS. 14-16, in which a narrower trench can be employed, such that floor surface 161 is necessary to fill the area between rear splash wall 155 and the edge of trench 147 nearest rear splash wall 155. Floor extension 161 may or may not be pitched given that it will normally cover a fairly small distance between splash wall 155 and trench 147.

3. Leak Proof Prefabricated Shower Pan Employing Standalone Pre-Manufactured Trenches and Standalone Standard Drains, Both of which are Integrally Molded in a Prefabricated Shower Pan at the Time the Shower Pan is Manufactured.

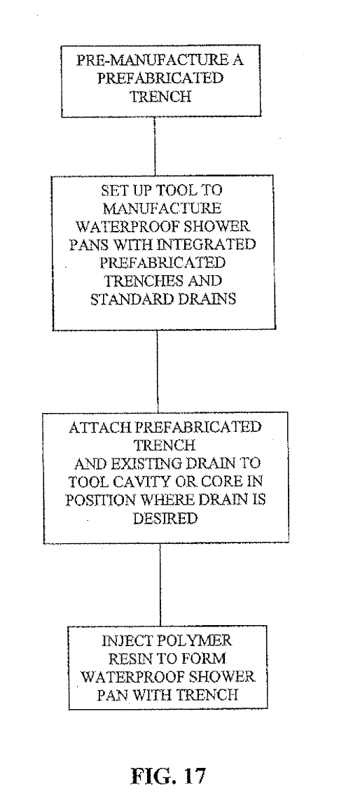

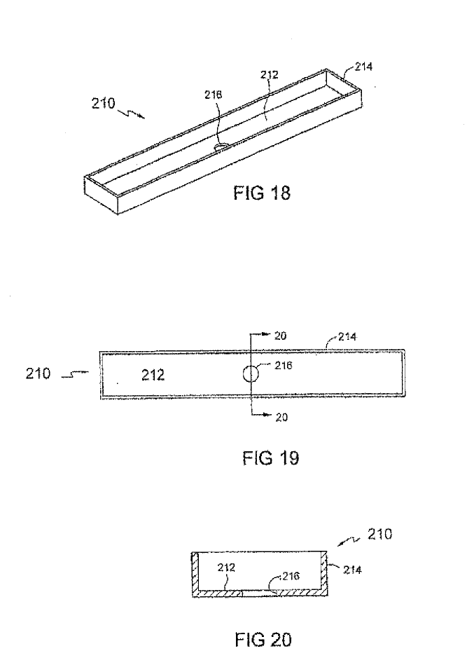

FIGS. 17-20 depict a still further alternative process for manufacturing waterproof shower pans. The process comprises the steps of: (i) pre-manufacturing a trench; (ii) setting up a tool to manufacture leak proof prefabricated shower pans with integrally formed pre-fabricated trenches and standard drains; (iii) attaching the pre-fabricated trench and a standard drain into the tool cavity or core in a position where the trench and drain are to be located; and (iv) injecting polymer resin into the tool to form a leak proof shower pan which are at least partially encapsulates a pre-fabricated trench and standard drain located at the drain aperture in the floor of the trench.

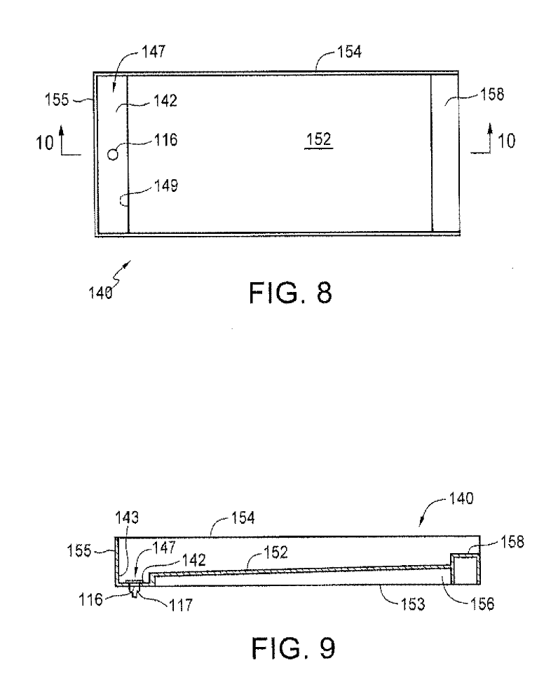

In order to manufacture a leak proof prefabricated shower pan having integrally formed therewith a pre-manufactured trench and a standard drain, a pre-manufactured trench such as trench 210 shown in FIGS. 18-20 is created, preferably through the process of reaction injection molding of polymer resin. Trench 210 may include a floor 12, sidewalls 14 and a drain aperture 16 in registry with which is to be attached a standard drain such as drain 117 shown in FIGS. 8-16. Pre-manufactured trench 210 is then placed in the cavity or core of a tool (not shown) used to manufacture the waterproof shower pan to be created, and drain 117 positioned in registry with aperture 216 in the tool, where after polymer resin is injected into the tool to create a waterproof shower pan and integrally connected pre-manufactured trench and standard drain. The resulting product may look similar to that shown in FIGS. 8-16.

4. Leak Proof Prefabricated Shower Pans with Pre-Manufactured Trenches and Standard Drains Attached to the Pre-Manufactured Trench as a Single Unit and Molded in the Prefabricated Shower Pan at the Time of Manufacture.

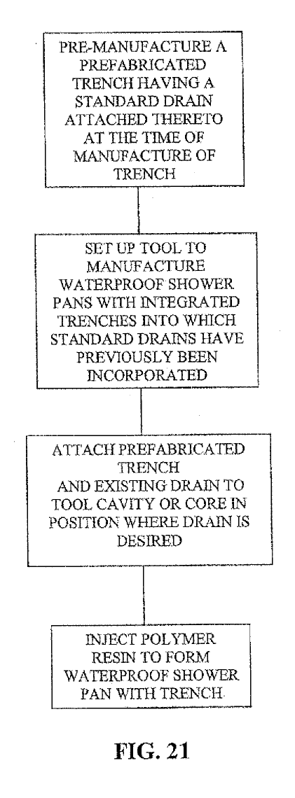

FIGS. 21-24 depict a flow diagram for a still further alternative manufacturing process and examples of constituent components used in connection therewith. The process comprises the steps of: (i) pre-manufacturing a trench 310 and having a standard drain 117 molded therewith at the time the trench is pre-manufactured (i.e. molded) or attaching the standard drain to the pre-manufactured trench after the trench is made but before it is incorporated (i.e. molded) into the prefabricated; (ii) setting up a tool to manufacture leak proof prefabricated shower pans having integrated trenches with attached standard drains; (iii) attaching the pre-manufactured trench with attached standard drain to the tool cavity or core in the position where the drain and trench are desired; and (iv) injecting polymer resin into the tool to form a leak proof prefabricated shower pan with a trench and standard drain.

The standard drain can be attached to the trench by any appropriate method, including, but not limited to, integrally molding the standard drain to the pre-manufactured trench, manually attaching the pre-manufactured trench to the standard drain by, for example, screws, nuts and bolts, adhesive, compression fittings, rivets, male or female solvent weld drain fitting formed on the underside of the trench at the drain aperture therein which is matched with a counterpart solvent weld male or female standard drain fitting and other appropriate connections.

As in the case of the invention disclosed in FIGS. 17-20, the product(s) which result from the process disclosed in FIG. 21 may appear similar to the products shown in FIGS. 8-16. Its is to be appreciated, however, that the products manufactured in accordance with the methods disclosed in FIGS. 17 and 21 may look different, as they may be made in any shape desired, and the components thereof may also be made in any desired shape.

5. Partially Pre-Fabricated Shower Pan Assemblies with Pre-Manufactured Trenches and Standard Drains as Two Independent Components Thereof.

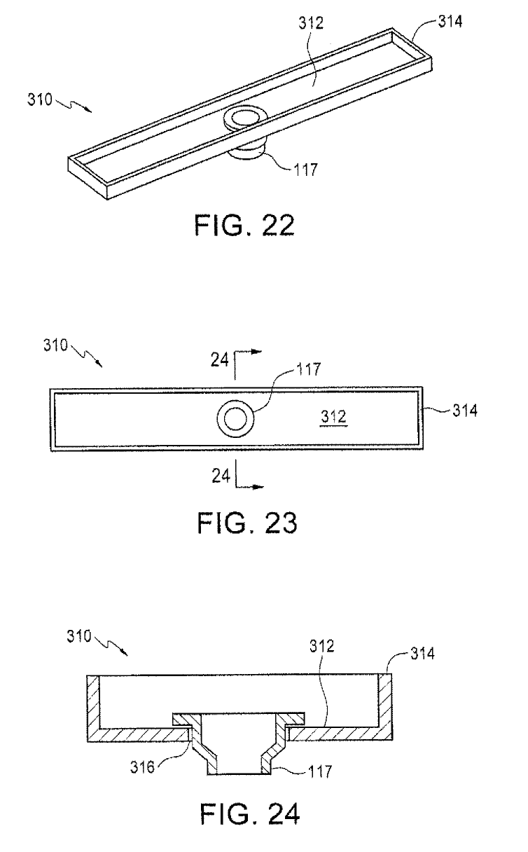

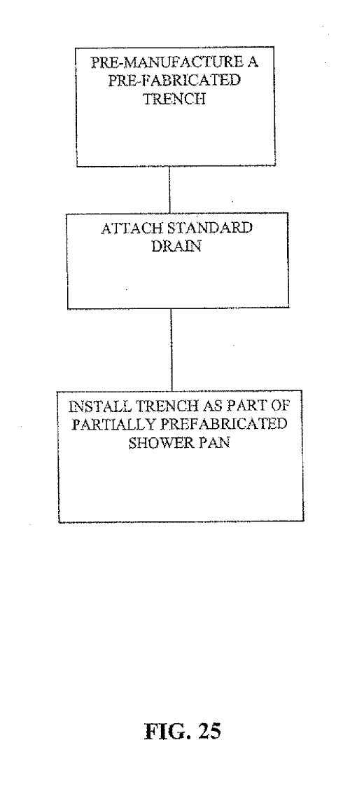

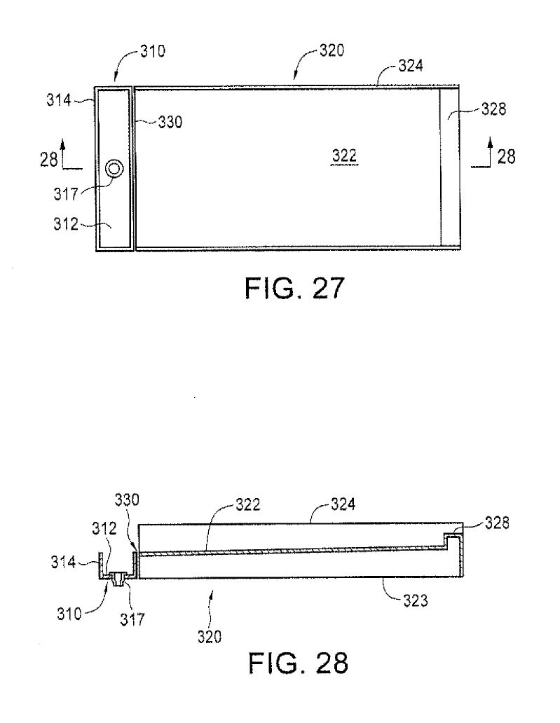

A process for manufacturing partially prefabricated shower pans which are adapted to be assembled in the field in accordance with the invention, and a representative product thereof, is shown in FIGS. 25-28. The process comprises the steps of: (i) pre-manufacturing a trench such as that shown in FIGS. 18-20 as reference number 210 as part of a partially prefabricated shower pan assembly; (ii) providing a standard drain 117, (iii) after manufacturing the pre-manufactured trench but before installation of the trench as part of, or while installing, the partially prefabricated shower pan assembly in the field, manually attaching the standard drain 117 to the pre-manufactured trench to produce a pre-manufactured trench and standard drain assembly such as item 310 in FIGS. 22-24; and (iv) installing a partially pre-fabricated shower pan assembly with the standard drain attached to the pre-manufactured trench.

The connection between the pre-manufactured trench and the standard drain may be a leak proof compression fitting, screws, nuts and bolts, rivets, adhesive connection, a male or female solvent weld drain fitting formed on the underside of the trench at the drain aperture therein which is matched with a counterpart solvent weld male or female standard drain fitting.

The pre-manufactured trench having a standard drain 117 attached thereto can be assembled in the field with a partially pre-fabricated shower pan such as pan 320. Pan 320 incorporates a floor member 322, defines a bottom surface 323, and may incorporate other features such as splash walls 324 and entry curb 328. Floor 322 defines a terminal edge 330 which is adapted to be placed in association with trench 310 when assembling the shower pan. Suitable waterproofing accommodations are made in the combining of trench 310 with pan 320. A standard drain is to be sealingly connected to trench floor 312 at aperture 316. Bottom surface 323 of pan 320 is preferably coextensive/coplanar with the bottom surface of trench 310.

6. Partially Pre-Fabricated Shower Pans with Pre-Manufactured Trenches and Standard Drains Attached to the Pre-Manufactured Trenches as One Component of a Partially Prefabricated Shower Pan Assembly.

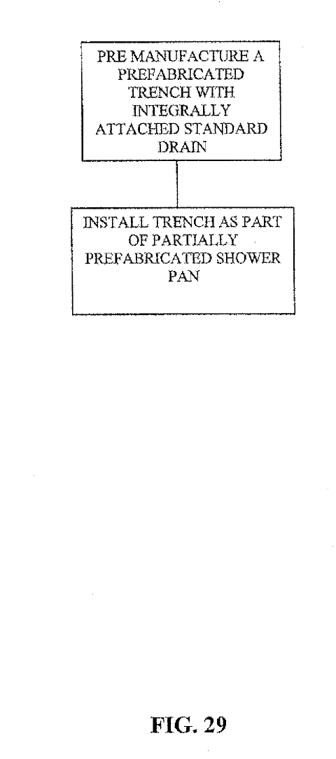

A still further process for manufacturing a prefabricated shower pan assembly in accordance with this invention is disclosed in FIG. 29. The process comprises the steps of: (i) pre-manufacturing a pre-fabricated trench having a standard drain integrally attached or manually attached thereto which is ultimately to become a single component of a partially prefabricated shower pan assembly; and (ii) installing the trench with the attached drain as a single component of a partially pre-fabricated shower pan assembly.

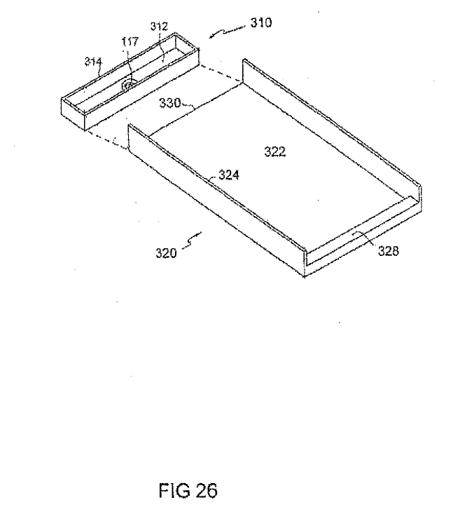

It is to be understood that FIGS. 26-28 show an exemplary product which can be made from the process depicted in FIG. 29. However, as is the case with all disclosed specific resulting products herein, the configuration, dimensions and methods of attachment of the components may vary.

The standard drain may be attached to the trench by any appropriate method, including, but not limited to, integrally molding the standard drain to the pre-manufactured trench, manually attaching the pre-manufactured trench to the standard drain by screws, nuts and bolts, rivets, adhesive, compression fittings, adhesive connection, a male or female solvent weld drain fitting formed on the underside of the trench at the drain aperture therein which is matched with a counterpart male or female solvent weld male or female standard drain fitting or any other standard drain connection or other suitable connections.

As described above, drain 117 can be attached to trench 310 either at the time that trench 310 is manufactured by molding the two into a single unit, or may be sealingly attached to the pre-manufactured trench 310 subsequent to the manufacture of trench 310. In either scenario, trench 310 with the attached standard drain 310 becomes a single component of a partially prefabricated shower pan assembly, or a mortar-based assembly installed in the field.

7. Partially Pre-Fabricated Shower Pans with Pan-Floor Having Integrally Formed Trench.

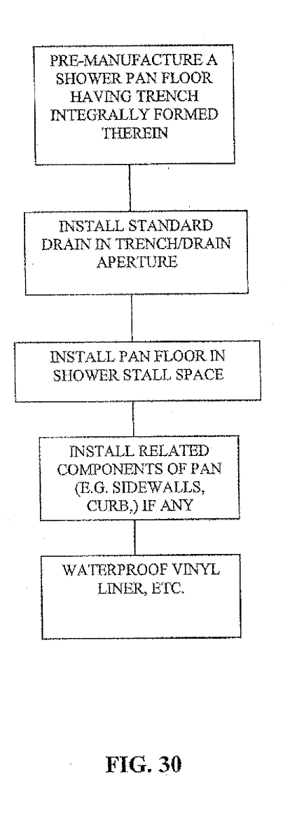

FIGS. 30-37 depict a process for manufacturing pre-fabricated waterproof shower pans wherein a shower pan floor is created separately as a component of a partially pre-fabricated shower, wherein a trench is formed into the shower pan floor, and examples of resulting products. The process for creating a pre-fabricated shower pan floor in accordance with this embodiment of the invention comprises the steps of: (i) pre-manufacturing a shower pan floor component of a partially pre-fabricated shower pan having a trench molded or integrally formed therein; (ii) placing the pre-manufactured shower pan floor with a molded trench therein in a space in which a shower is to be created; (iii) adding at least one related partially pre-fabricated shower pan assembly component part to such shower pan floor, such as additional floor components, a standard drain, a curb entry and/or splash walls; and (iv) connecting the shower pan floor and related components in watertight fashion.

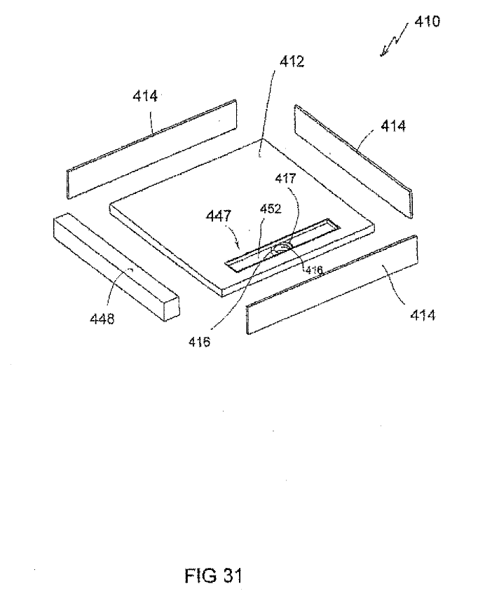

FIG. 31 is an exploded perspective view of an example of a partially pre-fabricated shower pan 410, which is comprised of a shower pan floor 412 and other pre-fabricated shower pan components. Such components may include, for example, but not by way of limitation, splash walls 414 and entry curb 448. A trench 447 is formed in floor 412. Trench 447 includes a floor 452 and a drain aperture 416 or standard drain body 417 nested within drain aperture 416. Pan floor 412 is manufactured such that trench 447 is integrally formed therewith. Aperture 416 may or may not be formed in trench 447 at the time trench 447 and pan floor 412 are formed. Standard drain 417 is incorporated in registry with aperture 416 either at the time of manufacture of pan floor 412 or subsequent to said manufacture.

In use, standard drain 417 is placed in registry with the waste water drain (not shown) in the subfloor (not shown) and the component parts such as splash walls 415, entry curb 448, etc, if any, are installed as well to form a partially pre-fabricated shower pan.

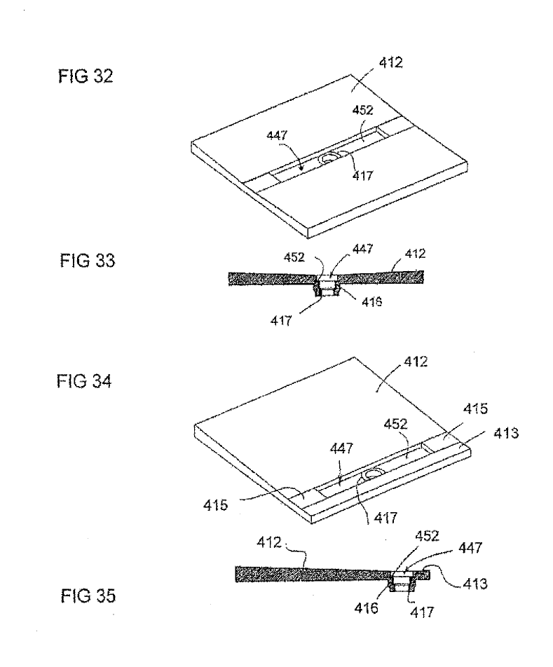

FIGS. 32-37 show alternative arrangements for partially prefabricated floor 412 of the partially prefabricated shower pan. The partially prefabricated floor 412 of FIG. 32 is similar to that of FIG. 31, but trench 447 is located centrally thereof. As stated previously, the trench 447 may be positioned at any location, and in any orientation, deemed desirable.

The partially prefabricated floor 412 shown in FIGS. 34-35 is similar to that of the partially prefabricated floor 412 of FIG. 31, but where pitched section 413 is provided in floor 412, which is pitched toward trench 447 to assist in the evacuation of water from floor 412 into trench 447. Side sections 415 of floor 412 may or may not be pitched toward trench 447.

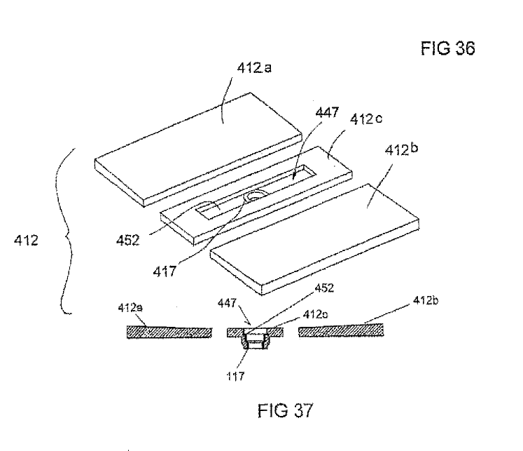

FIGS. 36-37 depict a still further construction of floor 412, which is comprised of floor sections 412a, 412b and 412c. In the embodiment shown (which can be deviated from as dictated by the designer), sections 412a and 412b are independently created, and are preferably pitched toward each other. Third floor section 412c has cut out therein a trench 447. During installation, floor sections 412a, 412b and 412c are placed in the space in which a shower is to be built, and connected with watertight seals therebetween, and standard drain 17 is connected to the waste water pipe in the subfloor. Thereafter, additional components, such as those shown in FIG. 31, can be added to complete the installation of a waterproof shower pan.

It is to be understood that the drains 417 shown in FIGS. 31-37 may be installed in the field, after the trench 447 is formed in floor 412, or may be integrally formed with trench 447 and floor 412 when floor 412 is formed.

8. Partially Pre-Fabricated Shower Pans with Pan-Floor Having Integrally Formed Trench with Integrally Connected Standard Drain.

The process for creating a pre-fabricated shower pan floor in accordance with this embodiment of the invention comprises the steps of: (i) pre-manufacturing a shower pan floor component of a partially pre-fabricated shower pan assembly having a molded or prefabricated trench with an integrally connected standard drain which is integrally formed therewith; (ii) placing the pre-manufactured shower pan floor in a space in which a shower is to be created; (iii) adding at least one shower pan component part to the shower pan floor, such as additional floor components, a curb entry and/or splash walls; and (iv) connecting the shower pan floor and related components in watertight fashion.

FIGS. 31-37 show representative examples of a prefabricated shower pan floors such as floor 52, 152, 322 into which have been formed a molded or prefabricated trench with a standard drain integrally connected thereto such as trench 310 of FIGS. 22-24.

It is also to be appreciated that the entryway into the shower need not be a curb such as curbs 58, 158, 328 or 448 but, rather, may be a barrier-free entry, a sidewall/splash wall, or any other arrangement.

9. Pre-Fabricated Trenches to which Standard Drain is Subsequently Attached as Two Components in a Mortar-Bed or Other Handmade Shower Pan Assembly.

Another process for manufacturing water-proof shower pans comprises the steps of (i) pre-manufacturing a trench such as the trench of FIGS. 18-20, and providing a standard drain which is to be attached to the thus-prefabricated trench to arrive at a trench such as that shown in FIGS. 22-24; and (ii) installing a mortar-bed or other handmade shower pan in conjunction with the prefabricated trench and standard drain.

Creation of shower pans from a mortar-base is well known. However, heretofore a pre-manufactured trench such as trench 210 shown in FIGS. 18-20 having a standard drain attached thereto after trench 210 is formed have not been disclosed. Standard stand alone trench drains have been the only type of linear drain heretofore used in connection with mortar-base shower pans. These standard linear drains are extremely expensive, as they are manufactured as completed drains in accordance with various plumbing codes. The use of the pre-manufactured polyurethane-type water proof trench components such as 210 greatly reduces the cost of producing a mortar-base shower pan. The incorporation of any one of the inexpensive standard drains into drain aperture 216 or trench 210 keeps the cost of such trenches with attached standard drains very low, rendering this product highly price competitive. Variations in the configuration and/or construction of the trench, such as trench 210, and any standard drain employed therewith, are contemplated. All that is required is that the trench and attached drain be of simple, inexpensive construction.

### 10. Pre-Fabricated Trenches Having Standard Drain Integrally Attached Thereto for Use in Mortar-Based Shower Pans as One Component.

Another process for manufacturing water-proof shower pans comprises the steps of (i) molding or prefabricating a trench with an integrally connected standard drain, such as the trench of FIGS. 22-24; and (ii) installing a mortar-bed or other handmade shower pan in conjunction with the molded or prefabricated trench with an integrally connected standard drain.

It is also to be understood that the trench 310 utilized in connection with the manufacturing processes set forth in FIGS. 25 and 29 may be used in the manufacture of mortar bed or other handmade shower pans. It is known to create shower floors out of flowable, hardenable construction materials such as mortar, wherein such material is placed on the sub-floor of a to-be-manufactured shower, the top surface of the material is sloped or pitched to permit drainage toward a floor drain, a waterproof liner or other waterproof membrane placed thereover, and finishing materials such as thinset and flooring tile placed thereover. It is contemplated that trench 320 can be utilized in such an arrangement, wherein standard drain 117 is attached to the waste water drain (not shown) adjacent to a mortar floor. The pre-manufactured waterproof trench 310 is sealingly connected to standard drain 117 in such a manner that water flowing from the mortar floor (not shown) into trench 310 will drain through standard drain 117 without leaking.

A mortar-base shower pan is manufactured using a trench and integrally attached standard drain. The standard drain is attached to trench 310 during manufacture of trench 310.

It is, of course, to be understood that the trench 310 shown in FIGS. 22-24 may be manufactured as one unit when trench 210 is molded, or may be created by the pre-manufacture of trench 210 and subsequent watertight attachment of a standard drain such as drain 117 thereto, resulting in an integrated trench and standard drain component of a mortar-base shower pan.

11. Prefabricated Shower Pans and Partially Prefabricated Shower Pans where (a) a Computer Numerically Controlled Lathe Makes One or More of a Trench, a Shower Pan Floor with a Trench, and a Shower Pan with a Trench and (b) a Standalone Standard Drain is Subsequently Attached to Such Trench.

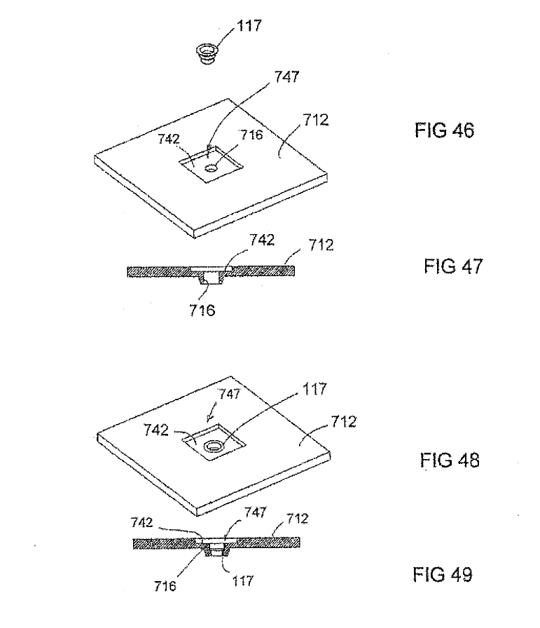

Products made from a still further process for manufacturing a prefabricated shower pan or a partially prefabricated shower pan assembly in accordance with this invention are disclosed in FIGS. 46-56. The process is comprised of the following steps: (a) forming one or more of a trench, a shower pan floor with a trench, and a shower pan with a trench, (b) molding a standard drain into a floor insert, (c) attaching the floor insert with the standard drain attached to the shower pan floor.

A shower pan or shower pan floor is formed with a trench out of any suitable waterproof material, such as by molding polymer resin or using a CNC device, including forming an aperture in the floor of the trench wide enough to fit a standard drain into. There may also be provided a nesting recess around the drain aperture into which the floor insert with attached standard drain (which is molded into a polyurethane panel corresponding to the recess, if such recess is provided) will be attached, using a water tight adhesive or the like.

The shower pans or shower pan floors, and trenches, made in accordance with the process described in the previous paragraph may take may different forms, including those shown in FIGS. 3-6, 8-16, 18-20, 22-24, 31-37 and 42-45.

### 12. Trench Mold

The mold for the trench tool permits the shower pan floor of a prefabricated shower pan, a partially prefabricated shower pan, and a mortar bed or other handmade shower pan, to be formed with a molded trench or prefabricated trench such that the trench (a) can be any length, width, depth and shape, (b) can be located anywhere in the shower pan floor, (c) can have any drain location in the trench, (d) can have multiple drain locations in the trench, (e) can have a standard drain attached to the trench, (f) can have a flat inside floor of the trench, (g) can have a molded or prefabricated V pitch incorporated into the trench at the time it is made which forms a V pitch from the narrow sides of the trench to the center of the trench floor to facilitate drainage from the trench, and (h) can have a molded or prefabricated pitch incorporated into the trench at the time the trench is made which forms a planar pitch from both long ends of the trench to the drain aperture in the trench to facilitate drainage of water.

A representative tool used to make the products disclosed herein has the following features: (a) a series of non pitched inserts of specified lengths that in a specific combination permits the trench to be made to any length, width, and to be placed anywhere in the tool; (b) tool pieces having floor pieces of specific sizes to which a matching trench insert can be attached which forms the trench of any length depending on how many pieces are used; (c) optionally different width pieces attached to the floor inserts which allows the trench to be of any width; (d) different depth pieces that can be interchangeably attached that allow the trench to be made to any depth; (e) inserts can themselves define, or have attachments associated therewith, that create topographical features in the floor of the trench, such as V pitching: (f) inserts can have additional attachments that create a planar pitch from each end of the trench to the aperture in the trench; (f) the drain insert can be located anywhere within the trench in small (e.g. ½ inch) increments by first locating the trench insert to which the drain insert is attached anywhere in the trench in small (e.g. one inch) increments and then, if necessary, adjusting the drain insert position on the trench insert by a smaller increment (e.g. ½ inch) either sideways or forward; (g) allows placement of multiple drains in the trench by placing multiple drain inserts in the tool.

### 13. Tileable and Non Tileable Trench Covers.

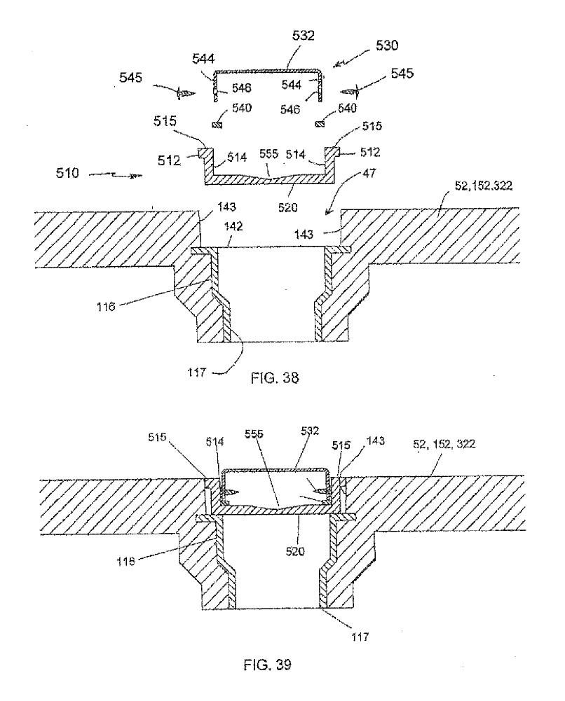

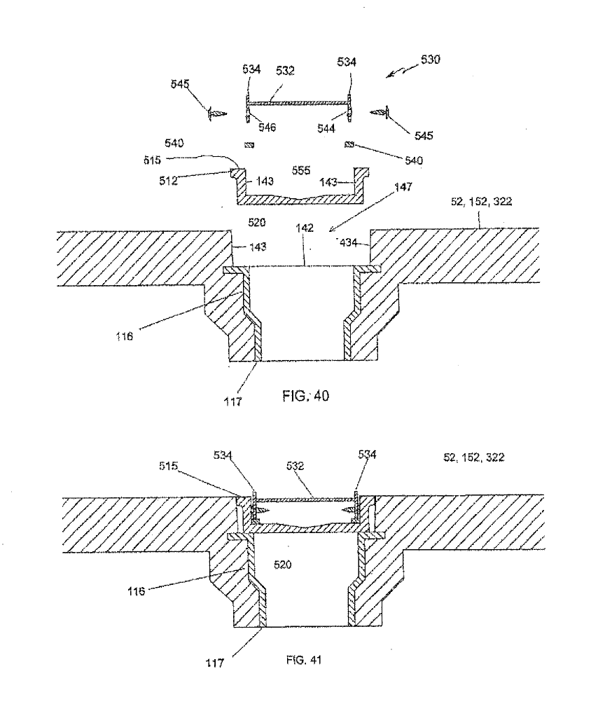

A trench cover 530 may be employed to be placed over trench insert 510 so as to conceal drain 177. Aperture 519 is adapted to be placed in registry with standard drain body 117 when trench insert 510 is placed in trench 147. Floor 520 may be pitched or flat. Pitching floor 520 as shown in FIGS. 38-43 facilitates the runoff of water toward drain aperture 519. In the embodiment shown in FIGS. 38-39, cover 530 is of the “non-tileable” variety, meaning that it is not intended that flooring material be placed there over. However, it is up to the discretion of the installer and/or designer as to whether flooring material will be placed on any of the covers disclosed herein. In the embodiment shown in FIGS. 40-41, cover 530 is of the “tileable” variety and may (but need not) include tile stops 534 adjacent upper surface 532 thereof. In the embodiment shown in FIGS. 38-39, trench cover 530 defines a planar top surface 532 without tile stops.

It is desirable, in connection with the non-tileable cover shown in FIGS. 38-39, that upper surface 532 be substantially coplanar with the upper surfaces of pan floor 52/152/322 so that no part of cover 530 protrudes above the surface of the pan floor. In order to accomplish this, spacers such as shims 540 may be employed to support cover 530 at the desired height. Shims 540 rest upon, and may even be adhered to or formed integrally with, floor 520 of trench insert 510.

As a way of releasably retaining cover 513 in association with trench insert 510, gripping means such as buttons 545 may be employed. Suitable provision for retaining buttons 545 in place relative to cover 530 may be provided by apertures 546 in depending legs 544 of trench cover 530. Buttons 530 press against sidewalls 143 of trench 47 to frictionally but removably hold cover 530 in place relative to trench 47.

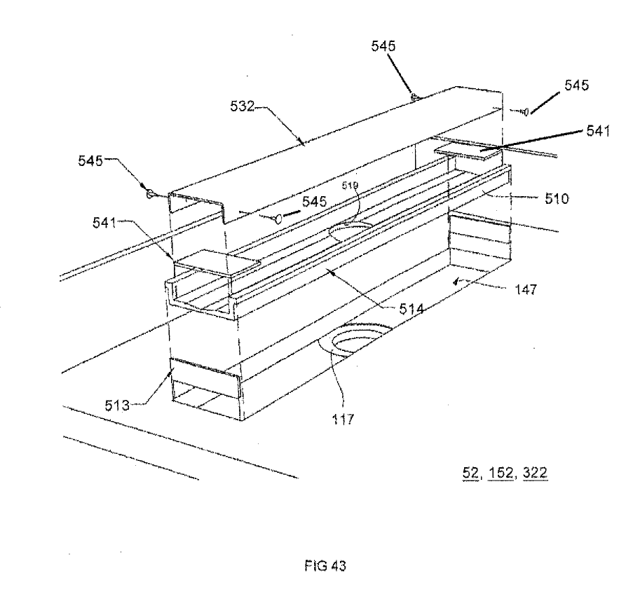

FIG. 43 depicts an alternative shim arrangement, wherein shims 541 are substituted for shims 540 shown in FIGS. 38-41. Shims 540 or 541 may be of any thickness or shape.

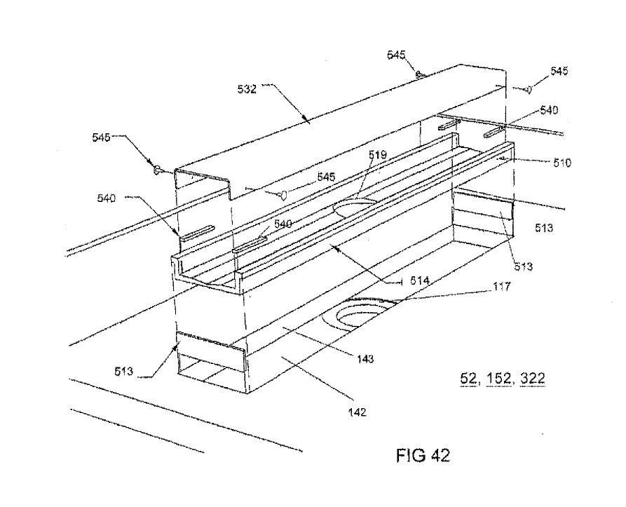

With respect to the embodiment shown in FIGS. 40-41, it is first to be appreciated that the embodiment shown in FIGS. 42-43 shows a non-tileable cover. However, it is to be understood that tileable cover 530′ shown in FIGS. 40-41 may be used in the arrangement shown in FIGS. 42-43.

The various trench covers disclosed herein may be of any suitable shape, the embodiment shown being substantially U-shaped, and sized and shaped relative to the trenches so as to define a linear or longitudinal gap between the sidewalls of the trench and the edges of the cover, which will permit water to drain therebetween. The height of the trench covers should be adjustable relative to the trenches and floors of the various shower pans so that, in the case of tileable covers, when the trench cover and shower pan floor are covered with finishing material, the top surfaces of such finishing material will be substantially coplanar, and, in the case of non-tileable trench covers, when the non-tileable trench cover is in place in the trench its upper surface is substantially coplanar with the adjacent finishing material on the pan floor. This arrangement will result in a substantially concealed drain arrangement. As described above, when the covers are placed in registry with the trenches, the peripheral edges of the covers are spaced from the sidewalls of the trenches so as to define a gap or grate free area there between through which water may pass while flowing toward drain. In this way, water is permitted to exit the shower, bath, sink or other such area without the drain aperture or drain body being visible.

The trench cover apparatus of this invention is preferably utilized as part of (i) a prefabricated shower pan, (ii) a partially prefabricated shower pan, (iii) a mortar bed or other hand made shower pan floor, and/or (iv) a tiled or tileable surface or fixture, whereby flooring or wall material such as tile may be attached up to (i.e. adjacent) the trench by epoxy, concrete, or any suitable wall or flooring adhesive, and additional flooring or wall coverings, if any, placed upon the trench cover with an appropriate wall or flooring adhesive. In this way, the trench cover can be made to have a finished look which matches the area surrounding or adjacent to the trench cover, with the drain and drain aperture fully operational yet unnoticeable. Alternatively or in addition, the trench cover may have openings in it through which water may drain.

In use, when the trench cover of the instant invention is connected to (i) a prefabricated shower pan, (ii) a partially prefabricated shower pan, (iii) a mortar bed or other hand made shower pan floor, and/or (iv) a tiled or tileable surface or fixture, the trench cover may be removed to permit access to the drain aperture and/or to permit installation of a strainer or like structure for cleaning and/or maintenance. Also, the building plumbing may be rooted out without requiring removal of the drain body so long as the trench cover is removed. When a non-perforated trench cover is installed upon the trench, it is intended to be virtually impossible to detect that a drain is even present.

The trench covers disclosed herein may be, as stated above, removable, and additional and/or replacement covers may be provided or sold separately to permit variation in the appearance of the drain and/or shower, bath, tub or basin. For example, a user may wish to use a first covering material such as floor or sink/tub/basin tile on a first cover, and a second, different, covering material on a second cover. Additional replacement covers may be provided with still further covering materials associated with them. For example, a user may wish to employ a decorative covering material on one cover, and his or her favorite sports team or celebrity on another, or a builder or hotelier may wish to have a unique feature or logo tiled onto the cover, and so forth.

However, it is also to be understood that a cover may be positioned in proximity to the trench in a manner that will preclude the removal thereof once connected. Also, the trench cover, or the trench integrated with a shower pan combined with a trough cover, may be manufactured as an integral unit.

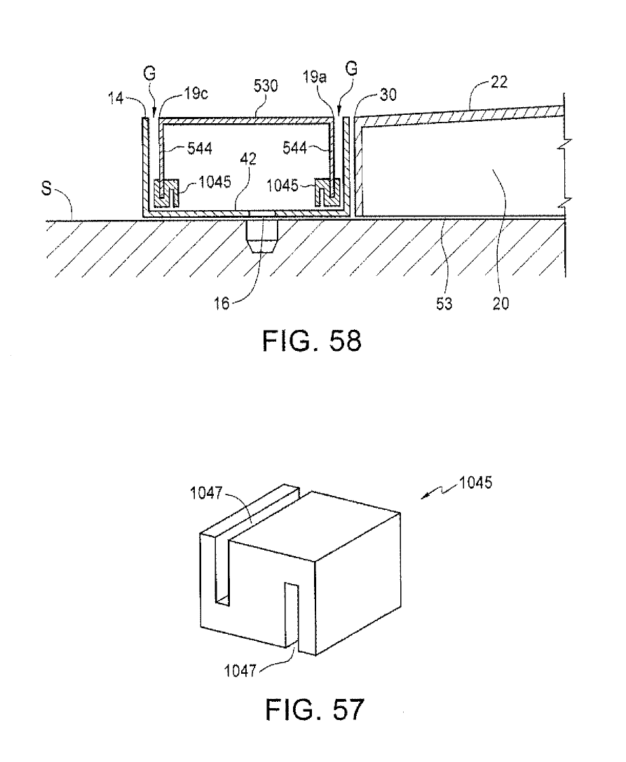

FIG. 57-58 depict a modified trench cover support for both supporting and permitting height adjustment of trench covers such as covers 530 and 530′, in the form of trench inserts 1045. The inserts are comprised of bodies into which are formed one or more slots 1047 which are adapted to receive the lower ends of cover support legs 544. Inserts 1045 may be rectangular or any other shape, and may be as long or short or as wide or narrow, as might be deemed desirable for a given situation. In addition, inserts 1045 may employ only a single slot 47. Still further, one or more such inserts 1045 may be used to support covers 530 and 530′ so as to adjust the height of the cover. Inserts 1045 are ideally to be spaced intermittently along trench body floor 142 so that water may drain between them.

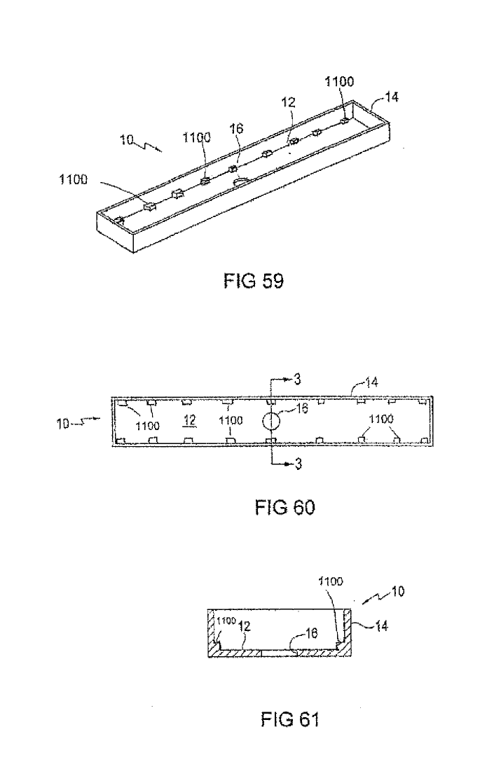

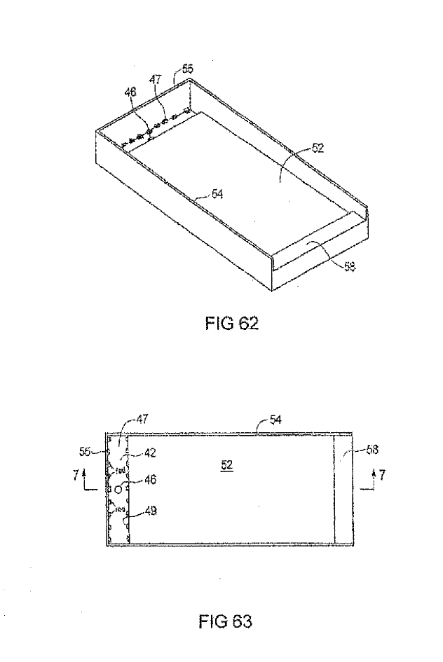

An alternative structure for supporting covers such as covers 530 and 530′ is shown in FIGS. 59-63 in the form of molded in or modular supports or spacers 1100. Spacers 1100 may be formed integrally with the trench floor and/or sidewalls during manufacture of the trench body, or may be independent pieces that the installer or other party may place in and/or connect to the trench body or covers 530 and 530′ after manufacture.

The drain covers 530 and 530′ may be retained in proximity to the trench through any attachment structure which allows the height of the upper surface of the drain cover to be positioned so that it is coplanar with an upper surface of the (A) prefabricated shower pan, (B) partially prefabricated shower pan, or (C) a mortar bed or other hand made shower pan floor, such attachment structure including but not limited to: (i) one or more inserts or (ii) molded-in structure such as supports 1100 on the trench body floor shown in FIGS. 21-28A to allow the height of the trench cover to be coplanar with the surface of the floor of the shower pan adjacent to the trench cover, or (iii) insert attached to the bottom on a flat or pitched trench or trench liner, or (iv) any other arrangement that allows the trench cover to be adjustably positioned relative to the shower pan floor at a height described above.

### 14. Modular Trench Inserts and Liners

A trench insert 510 maybe employed to change the actual size of the trench opening or to simply create a more suitable trench interior. Trench insert 510 is sized and shaped so as to fit fairly tightly within trench 47 and to correspond substantially in shape thereto. Trench insert 150 is generally U-shaped in cross-section, and may have extensions 512 on either side thereof which define surfaces that are adapted to press against sidewalls 143 of trench 47. Extensions 512 form a space between upstanding legs 514 of trench insert 510 and sidewalls 143 of trench 47. In this way, trench insert 510 need not be of precise external contour, which could make for potential problems in fitting well within trench 47 should any debris or undulations be present on floor 142 of trench 147.

Extensions 512 define upper surfaces 515 thereof, which are adapted to lie in substantially the same plane as the upper surface of pan floor 52/152/322.

It is also to be understood that floor 520 of trench insert 510 may consist of a uniform pitch from the outer most ends thereof (away from aperture 519) toward aperture 519 to facilitate the runoff of water. Alternatively, the V-shaped channel 555 formed in floor 520 may itself pitch toward aperture 519 on either side of aperture 519.

It is also to be understood that floor 12, 142, 212, 312 and/or 520 of the various trenches disclosed herein may be shaped like floor 520 of trench insert 510. Alternatively, said trench floors made have a uniform pitch from each end of the trench toward the drain aperture defined by the trench floor (which may or may not be located in the center of the trench, depending upon the location of the floor drain).

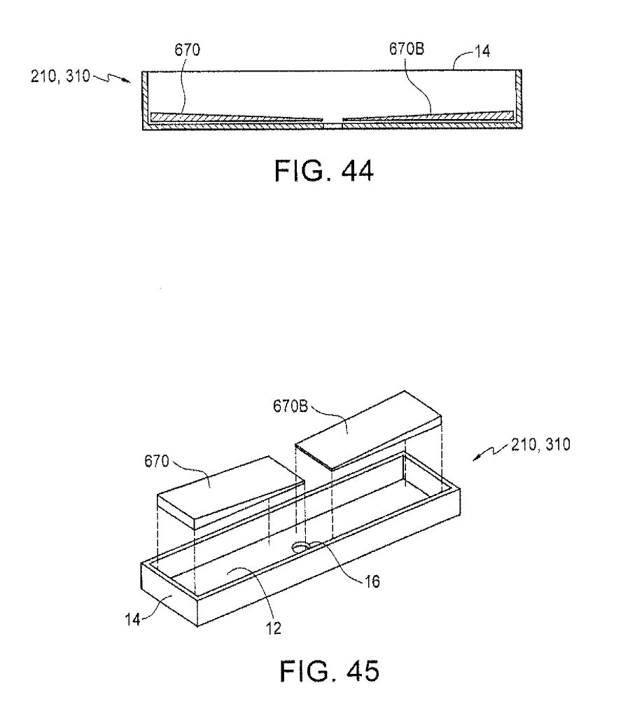

Alternatively, a pitch may be accomplished in the floor of the various trenches disclosed herein by the placement of wedge/shaped inserts atop said trench floors. As best seen in FIGS. 44 and 45, in the interest of manufacturing expediency, given that the aperture 116 in the trench body may be located at any position along the floor 142 thereof, in certain cases it is desirable, although not necessary, to manufacture trench 47, or any of the other trench structures disclosed herein, with a non-pitched, or horizontal, floor. In other cases it may be desirable, although not necessary, to provide a trench with a constant V pitch from both width sides to the center of the trench to move the water to the drain. Otherwise, a different tool would be needed to manufacture each product which had a new drain location, because the pitch that would have to be imparted into the trench floor where the aperture is centrally located, such as that shown in FIG. 8, is entirely different from the pitch that would have to be imparted in a trench floor if the aperture were located in a different position relative to the ends of the trench. To this end, pitched floor inserts 670 are proposed, which are far less expensive to manufacture than a separate tool for an entirely new product.

Insert pairs 670a, 670b may be used to accomplish the task. Each insert half is a wedge-shaped component which is placed on the floor of the trench. Wedge halves 670a and 670b may be secured by mechanical fasteners such as adhesive or other mechanical coupling, or may simply be laid upon the trench floor. The upper facing surfaces of inserts 670a, 670b may be planar, or, alternatively, may be V-shaped to cause water to flow medially of said surfaces and to be channeled toward drain aperture 116. Inserts 670a, 670b may be manufactured by molding, extruding, by modifying existing wedge-shaped material, or any other expedient method.

The shape of the trenches shown herein (rectangular) is by way of example only. It is to be appreciated that the trenches may be made in any desired shape without departing from the spirit or scope of the invention. In addition, any number of trench structures of this invention may be employed in any given shower pan.

Likewise, the trenches disclosed herein may employ one or more of the many types of standard drains which may be connected to one or more openings in the bottom of the trench, which standard drains are then connected to a waste water system. Such standard drains include, without limitation, hub drains, no hub drains, solvent weld drains, compression drains, welded drains, outside caulk drains, inside caulk drains, spigot drains, hubless spigot drains, hubless drains, inside caulk(gasket) drains, hubbed (push on) drains, compression drains, clamping ring drains, etc.

FIGS. 46-55 depict alternative shower pan floor and trench arrangements. It is to be understood that these shower pan floor and trench arrangements may be incorporated into prefabricated shower pans, or may be used as the floor component of partially prefabricated shower pans. It is also to be understood that these products may be manufactured using injection molding techniques or using the CNC techniques discussed previously.

FIGS. 46-47 show a shower pan 712 into which is integrally incorporated a trench 747, the trench defining a trench floor 742, which in turn defines a drain aperture 716. A standard drain such as standard drain 117 is adapted to be placed in registry with drain aperture 716 and secured thereto in water tight fashion after manufacture of pan floor 712 with integrated trench 747. As can be seen, trench 747 is square, but may be elongated/linear such as the trenches shown in the previous drawings herein, round, or any other shape or dimension. Drain 117 may be affixed to drain aperture 716 post manufacture, either in a subsequent manufacturing step, in the field during installation of the shower pan, in a shower space, or any time therebetween.

FIG. 48 depicts a shower pan floor in which a standard drain such as standard 117 has been integrally formed at the time of manufacture of pan floor 712. To manufacture the pan shown in FIGS. 48-49, standard drain 117 is placed within the cavity and core of a tool used to mold pan 712, and polymer resin injected therein to create the pan 712 with an integral trench 747 and integrated standard drain 117.

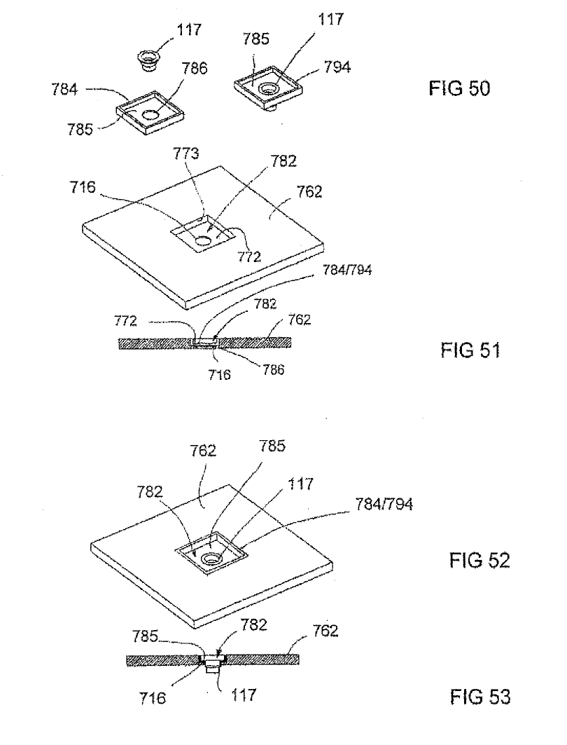

FIGS. 50-51 show alternative arrangements for affixing a standard drain such as standard drain 117 to a shower pan floor. In a first version, a trench insert 784, which defines a drain aperture 786, is separately manufactured from pan floor 762. Standard drain 117 is connected to trench insert 784 into drain aperture 786 after trench insert 784 is manufactured. Thereafter, trench insert 784 with integrated standard drain 117 is affixed into trench 782 of pan 762. In one embodiment, adhesive is placed upon trench floor 772, and trench insert 784 inserted therein. Alternatively or additionally, adhesive may be applied to trench sidewalls 773.

An alternative trench insert is shown in FIGS. 50-51 in the form of trench inserts 794 with integrated standard drain 117. Trench insert 794 is manufactured in such a way that standard drain 117 is integrated therewith at the time trench insert 794 is manufactured. Trench insert 784 is to be attached to shower pan floor 762 in the manner discussed in connection with trench insert 784.

FIGS. 52-53 show pan floor 762 having attached thereto trench inserts 784 or trench inserts 794. In either case, water drains from pan floor 762 into trench 785 and drain 117.

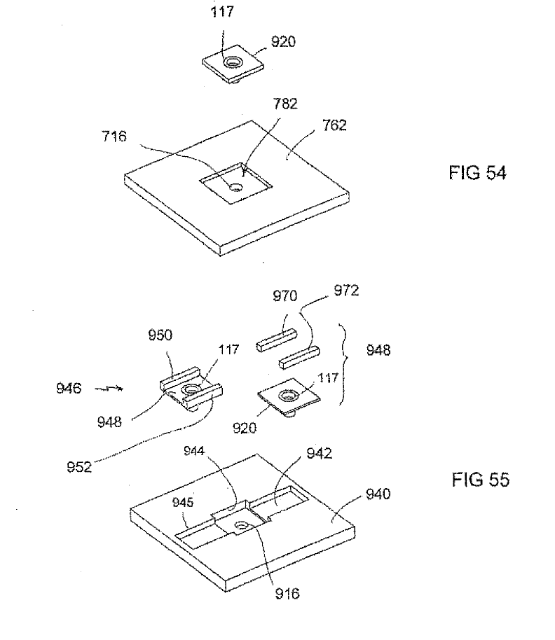

FIG. 54 depicts a still further version of a shower pan floor and trench arrangement. The arrangement of FIG. 54 is similar to that shown in FIGS. 50-53, but instead of utilizing trench inserts 784, 794, which both have upstanding sidewalls, the trench insert 920 does not have sidewalls, but rather fits within trench 782 of pan floor 762 in similar fashion to the way trench inserts 784, 794 are placed within trench 782. Trench insert 920 may be formed with or without an integrated standard drain 117. That is, standard drain 117 may be affixed to trench insert 920 after trench insert 920 is manufactured, or may be manufactured simultaneously in the same tool with trench insert 920. In either event, trench insert 920 with integrated standard drain 117 is affixed within trench 782 of pan floor 762 to create a water tight seal.

FIG. 55 shows an alternative pan floor and trench with trench insert. Alternative versions of trench inserts are disclosed. Shower pan floor 940 is formed having an elongated trench 942 integrally formed therewith. A drain aperture 916 is defined by the floor of trench 942. As trench inserts 946 or 948 are to be inserted into trench 942, in the event that the width of trench 942 is larger than the width of trench inserts 946 and 948, an enlarged space 944 is made in trench 942 to accommodate trench inserts 946 or 948.

Trench insert 946 is comprised of a trench floor 948 having a standard drain 117 integrally formed therewith, or attached thereto after trench insert floor 948 is manufactured. In the event that trench insert 946 is wider than trench 942, such that enlarged space 944 is needed, a pair of fillers such as filler sections 950, 952 may be integrally formed with trench insert 946 to occupy the space defined by enlarged space 944 beyond the space provided within trench 942 where trench insert 946 is to be installed. In this way, once trench insert 946 is placed within trench 942 in the enlarged space 944, a uniform linear trench 942 will be provided, into which can be placed a trench cover, and surrounding which finishing material may be applied.

Alternative trench insert 948 is substantially similar to trench insert 946, but is manufactured from modular sections 970, 972 in lieu of spacers 950, 952 shown in trench insert 946. In other respects trench insert 948 is substantially the same as the structure and operation of trench insert 946.

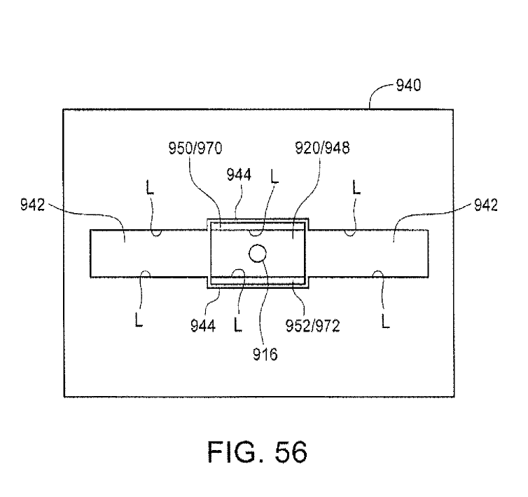

FIG. 56 is a top plan view of the assembled shower pan floor 940 and trench inserts 946, 948. As can be seen, the trench sidewalls and the inner facing surfaces of filler blocks 950, 952 or 970, 972 form a substantially uniform line L which defines the perimeter of trench 942. Finishing material may be laid up to line L to form a uniform transition edge into trench 942. Tile stops (not shown) may also be used to outline line L to assist in laying finishing material in a straight and uniform manner.

It is also appreciated that specific disclosures or drawings disclosed herein in connection with one or more specific embodiments, drawings, claims or applications also have application in connection with other embodiments, drawings, claims and applications, including but not limited to the following:
a. That a depicted entryway into a shower may be on any side of the shower and the entrance contemplates and comprises arrangements such as one or more curbs of any height and one or more barrier free entrances.
b. That a depicted or described connection arrangement between two or more components such as a standard drain, a shower pan with a molded trench, a prefabricated trench, a trench drain, and a shower pan floor, comprises and contemplates any other connection arrangement.
c. That a depicted drain apparatus and drain connection comprises and contemplates any other drain apparatus or connection, including a vertical drain connection and a side drain connection.
d. That a depicted location of a standard drain in a shower pan floor contemplates any other location or multiple locations of a standard drain in a shower pan floor.
e. That a depicted location of a molded trench in a shower pan floor contemplates any other location or multiple locations of a molded trench in a shower pan floor.
f. That a depicted location of a prefabricated trench in a shower pan floor contemplates any other location or multiple locations of a prefabricated trench in a shower pan floor.
g. That a depicted location of a standard drain connected to a molded or prefabricated trench contemplates any other location or multiple locations of a standard drain connected to a molded or prefabricated trench.
h. That a depicted location of a standard drain connected to a molded or prefabricated trench in a shower pan floor contemplates any other location or multiple locations of a standard drain connected to a molded or prefabricated trench in a shower pan floor.
i. That the shower pans, shower pan floors and the trenches depicted and described herein in any drawing or paragraph may take different forms including those depicted or described in other drawings or paragraphs herein.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made while this application is pending and all equivalents of those claims as issued.

What is claimed is:

1. A tool for molding prefabricated recessed trenches, comprising:
a cavity half and a core half; and
a collection of interchangeable inserts, each insert defining a portion of a trench surface-forming tool surface, said inserts, when selected and installed in the respective cavity and core halves of the tool in a prearranged orientation, collectively forming the entire trench surface-forming surface of the tool, the inserts being positioned in the respective cavity and core halves of the tool such that, when the cavity and core halves of the tool are mated together, the trench surface-forming surfaces of the inserts collectively define a volume corresponding to a shape of the trench to be formed.

2. The tool of claim 1, wherein the collection of interchangeable inserts is comprised of a group of cavity-side inserts, and a group of core-side inserts, from which groups can be selected a variety of individual inserts to be used in the core and cavity halves of the tool, respectively, to form any number of differently shaped trenches of any dimension.

3. The tool of claim 1, wherein the shape of the trench formed using the tool can be any width, length, and depth.

4. The tool of claim 1, wherein the inserts define a trench having a volume which is rectangular, square, round, oval, or star shaped.

5. The tool of claim 1, wherein the inserts form a trench having a trench floor with no pitch.

6. The tool of claim 1, wherein the inserts form a trench which defines a trench floor, and at least a portion of which trench floor defines a V-shaped channel.

7. The tool of claim 1, wherein the inserts form a trench which defines a trench floor, and at least a portion of which trench floor slopes toward a drain aperture defined by said trench floor.

8. The tool of claim 3, wherein the width, length, and depth of the trench is varied by varying the combination and number of inserts used to form the trench.

9. The tool of claim 1, wherein one or more apertures are formed in a floor of the trench.

10. The tool of claim 1, wherein one or more standard drains are integrally molded or otherwise connected to the trench either at the time the trench is formed or any time thereafter.

11. The tool of claim 1, wherein the trench is formed as part of a tileable shower pan floor.

12. The tool of claim 1, wherein the trench is formed as a standalone component of, and is adapted to be installed adjacent to, a shower pan floor.

13. The tool of claim 1, wherein the trench is formed substantially simultaneously with a tileable shower pan, said trench being recessed into a floor of said shower pan.

14. The tool of claim 1, wherein the trench inserts form a trench from a group of trenches consisting of (a) standalone prefabricated shower pan trenches recessed relative to an adjacent tileable shower pan floor, (b) prefabricated shower pan trenches formed simultaneously with, as part of, and recessed into, a tileable shower pan floor, and (c) prefabricated shower pan trenches formed simultaneously with, as part of, and recessed into a floor of, a tileable shower pan.

15. The tool of claims 1 through 14, wherein the trench is formed as a component of a tileable shower pan selected from prefabricated shower pans, partially prefabricated shower pans, and mortar bed or other handmade shower pans.

16. A method of manufacturing prefabricated trenches for use in association with tileable shower pans, comprising;
providing an injection molding tool having a cavity-side base and a core-side base;
providing a collection of core-side trench surface-forming inserts;
providing a collection of cavity side trench surface-forming inserts;
the collection of core-side inserts and the collection of cavity-side inserts each including enough inserts from which to manufacture trenches of a wide variety of dimensions by attaching groups of said core-side inserts to said core base and attaching groups of said cavity-side inserts to said cavity base, respectively, and forming one or more trenches therefrom by injection molding.

17. The method of claim 16, wherein the shape of the trench formed by the inserts can be any width, length, depth, shape and dimension.

18. The method of claim 16, wherein the inserts form a trench which can be any one of rectangular, square, round, oval, and star shaped.

19. The method of claim 16, wherein the inserts form a trench having a trench floor with no pitch.

20. The method of claim 16, wherein the inserts form a trench which defines a floor, at least a portion of which floor defines a V-shaped channel.

21. The method of claim 16, wherein the inserts form a trench which defines a floor, at least a portion of which floor slopes toward a drain aperture defined by said floor.

22.

23. The method of claim 17, wherein the width, length, and depth of the trench is varied by varying the combinations and numbers of inserts used in the tool to form the trench.

24. The tool of claim 16, wherein one or more apertures are formed in a floor of the trench.

25. The method of claim 16, wherein at the time the trench is formed, a standard drain is integrally molded and connected to the trench.

26. The method of claim 16, wherein the trench is formed as part of a shower pan floor.

27. The method of claim 16, wherein the trench is formed as a separate component of, adapted to be attached to, a shower pan floor.

28. The method of claim 16, including selecting cavity-side inserts corresponding to an interior floor surface of said trench which result in the manufacture of a substantially horizontally disposed trench floor.

29. The method of claim 16, including selecting cavity-side inserts corresponding to an interior floor surface of said trench which result in the manufacture of a trench floor which is substantially sloped toward a drain opening defined by the trench floor.

30. The method of claim 16, further comprising the steps of:
removing one or more of the core-side inserts from the tool;
removing one or more of the cavity-side inserts from the tool;
selecting a group of secondary inserts from the collection of core-side inserts, and selecting a corresponding group of secondary inserts from the collection of cavity-side inserts, and attaching said group of secondary core-side and secondary cavity-side inserts to the core and cavity bases of the tool, respectively, to be used to manufacture trenches having different dimensions and/or proportions from the trenches which can be manufactured from the tool set forth in claim 1.

31. The method of claim 16, wherein the trench is from a group of trenches consisting of (a) a standalone prefabricated shower pan trench recessed relative to an adjacent tileable shower pan floor, (b) a prefabricated shower pan trench formed simultaneously with, as part of, and recessed into, a tileable shower pan floor, and (c) a prefabricated shower pan trench formed simultaneously with, as part of, and recessed into a floor of, a tileable shower pan.

32. The method of any of claims 16 through 31, wherein the trench is formed as a component of a tileable shower pan selected from the group of tileable shower pans consisting of prefabricated shower pans, partially prefabricated shower pans, and mortar bed or other handmade shower pans.
